(19) United States
(12) Patent Application Publication
(10) Pub. No.: US 2020/0174388 A1
(43) Pub. Date: Jun. 4, 2020

(54) TWO-COMPONENT DEVELOPER FOR ELECTROSTATIC CHARGE IMAGE DEVELOPMENT

(71) Applicant: Konica Minolta, Inc., Tokyo (JP)

(72) Inventors: Koji SHIBATA, Tokyo (JP); Shinya OBARA, Tokyo (JP); Junya UEDA, Tokyo (JP); Takuya TAKAHASHI, Tokyo (JP)

(21) Appl. No.: 16/658,912

(22) Filed: Oct. 21, 2019

(30) Foreign Application Priority Data
Nov. 29, 2018 (JP) 2018-223588

(51) Int. Cl. G03G 9/087; G03G 9/097; G03G 9/113; G03G 9/08

(52) U.S. Cl. CPC G03G 9/08755; G03G 9/0819; G03G 9/1136; G03G 9/09708

(57) ABSTRACT

It is a two-component developer for electrostatic charge image development, which contains toner containing at least a binder resin and an external additive on a surface and a carrier containing a resin layer at least on a surface of a core material. The binder resin contains a crystalline polyester resin, the external additive contains alumina particles, and the resin layer contains a silicone resin.

### CROSS-REFERENCE TO RELATED APPLICATION

The entire disclosure of Japanese Patent Application No. 2018-223588, filed on Nov. 29, 2018, is incorporated herein by reference in its entirety.

### BACKGROUND

### 1. Technical Field

The present invention relates to a two-component developer for electrostatic charge image development.

### 2. Description of Related Arts

In image output using the electrophotographic process, toner exhibiting excellent low-temperature fixability has been demanded for fixing a toner image with less energy than before from the viewpoint of speeding up and energy saving in recent years. In order to lower the toner fixing temperature, it is required to lower the melting temperature and melt viscosity of a binder resin constituting the toner. In order to achieve such low-temperature fixing of toner, toner containing a crystalline polyester resin as a binder resin has been proposed. The crystalline polyester resin has a melting point and exhibits a sharp melt property and thus is advantageous from the viewpoint of securing the low-temperature fixability of toner.

However, it is disadvantageous to contain a crystalline polyester resin from the viewpoint of spent on the carrier when the developer is endured (used for a long time) since the toner is soft even at a temperature close to normal temperature while it is advantageous to contain a crystalline polyester resin from the viewpoint of low-temperature fixing. Here, spent refers to a phenomenon in which the carrier and the toner collide each other when the toner and the carrier are sintered in the developing machine so that load is applied to the toner and the toner is crushed and fixed to the vicinity of the carrier.

Meanwhile, it is known that the toner is hardly spent on the carrier as a silicone resin having low surface energy is used in the covering layer of the carrier (see, for example, JP 2011-112839 A).

### SUMMARY

However, there is a problem that the suppression of spent is still insufficient even when toner containing a crystalline polyester resin and a carrier containing a silicone resin are combined as the technology described in JP 2011-112839 A. In addition, the silicone resin has a problem that the stability of charging is low and, as a result, fogging deteriorates.

Accordingly, an object of the present invention is to provide a means capable of suppressing both spent and fogging while maintaining low-temperature fixability.

The present inventors have conducted intensive investigations in view of the above problems. As a result, the present inventors have found out that the problems can be solved by the following two-component developer and thus have completed the present invention.

In order to achieve at least one of the objects described above, a two-component developer reflecting an aspect of the present invention is a two-component developer which contains toner particles containing at least a binder resin and an external additive on the surface and carrier particles containing a resin layer at least on the surface of a core material and in which the binder resin contains a crystalline polyester resin, the external additive contains alumina particles, and the resin layer contains a silicone resin.

### BRIEF DESCRIPTION OF THE DRAWINGS

The advantages and characteristics to be provided by one or more embodiments of the present invention can be more fully understood by the following detailed description and the accompanying drawings. It should be noted that the drawings are illustrated for illustrative purposes only and are not intended to define the scope of the present invention.

FIG. 1 is a schematic diagram of an apparatus for separating and collecting a carrier in a two-component developer. In FIG. 1, 11 denotes a conductive sleeve, 12 denotes a magnet roll, 13 denotes a bias power source, and 14 denotes a cylindrical electrode, respectively.

FIG. 2 is a schematic diagram of an instrument for carrier filling to be used for the measurement of the volume resistivity of a carrier constituting a two-component developer of the present invention. In FIG. 2, 21 denotes a cell composed of a fluororesin vessel, 22a and 22b denote an electrode, and 23 denotes a carrier, respectively.

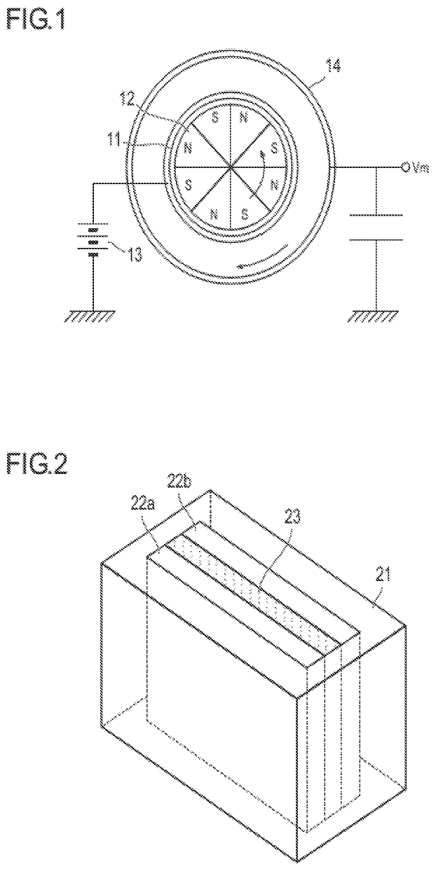

### DETAILED DESCRIPTION OF THE EMBODIMENT

Hereinafter, one or more embodiments of the present invention will be described with reference to the drawings. However, the scope of the invention is not limited to the disclosed embodiments. In the description of the drawings, the same elements are denoted by the same reference numerals, and redundant description is omitted. In addition, in some cases, dimensional ratios in the drawings are exaggerated and different from actual ratios for convenience of the description.

In the present specification, the operations and the measurements of physical properties and the like are performed under the conditions of room temperature (20° C. or more and 25° C. or less)/relative humidity of 40% RH or more and 50% RH or less unless otherwise stated.

[I] Two-Component Developer

A two-component developer (hereinafter also simply referred to as “developer”) according to an embodiment of the present invention is a two-component developer which contains toner particles containing at least a binder resin and an external additive on the surface and carrier particles containing a resin layer at least on the surface of a core material and in which the binder resin contains a crystalline polyester resin, the external additive contains alumina particles, and the resin layer contains a silicone resin. The two-component developer of the present embodiment having such a configuration can suppress both spent and fogging while maintaining low-temperature fixability.

The exertion mechanism and action mechanism (mechanism) by which the above-described effects of the two-component developer of the present embodiment are attained are not clear but are presumed as follows.

The following two are conceivable as the reason why the suppression of spent is still insufficient even on a carrier containing a silicone resin exhibiting a high spent resistance in the case of using toner containing a crystalline polyester resin. The first reason is an increase in adhesive force of the toner due to the external additive detachment from the toner in the developing machine, and the second reason is the softening of the toner and an increase in the adhesive force accompanying an increase in the developer temperature by the carrier having a silicone resin having a low thermal conductivity.

Here, when alumina having higher Mohs hardness than other external additives is used as an external additive, alumina is likely to be buried in the toner base particles because of the difference in hardness from the toner base particles, the adhesive strength increases, and the detachment of the external additive in the developing machine is suppressed. In addition, alumina has a high thermal conductivity and thus an increase in the temperature of the developer can be suppressed and softening of the toner can also be suppressed. As a result, the adhesive force of the toner can be sufficiently diminished in the developing machine as well and spent is suppressed.

In addition, the alumina external additive is hardly detached in the developing machine as well, thus charging stability of the toner is also enhanced and fogging is also suppressed.

Furthermore, the alumina external additive hardly inhibits heat conduction to the toner base particles at the time of fixing, it is thus possible to maintain low-temperature fixability, to suppress spent of the toner on the carrier, to suppress fogging, and to attain the above-described effects.

It should be noted that the exertion mechanism and action mechanism (mechanism) are based on presumption and the present invention is not limited to the mechanisms at all.

Hereinafter, the two-component developer of the present embodiment will be described in detail. Incidentally, the two-component developer according to the present invention contains toner and a carrier. Here, the toner contains “toner base particles”. The “toner base particles” are called “toner particles” as an external additive is attached to the surface thereof. Moreover, “toner” refers to an aggregate of “toner particles”. Hereinafter, the toner and the carrier will be described separately.

<Toner>

[Toner Base Particles]

The toner base particles constitute the base of toner particles. The toner base particles according to the present embodiment contain a crystalline polyester resin as a binder resin and may contain other toner constituents (internal additives) such as a colorant, a release agent (wax), and a charge control agent, if necessary.

The method for producing the toner base particles according to the present embodiment is not particularly limited, and may be a dry method, but a wet production method (for example, an emulsion aggregation method and the like) in which the toner base particles are fabricated in an aqueous medium is preferable.

<Binder Resin (Amorphous Resin and Crystalline Resin)>

The toner base particles according to the present embodiment contain at least a binder resin, and the binder resin contains a crystalline polyester resin. The crystalline polyester resin has a melting point and exhibits a sharp melt property and thus is advantageous from the viewpoint of securing the low-temperature fixability of toner. In the present embodiment, the binder resin preferably contains an amorphous resin and a crystalline resin (crystalline polyester resin).

[Crystalline Resin]

The crystalline resin to be used in the toner according to the present invention contains a crystalline polyester resin. The crystalline polyester resin has a melting point and exhibits a sharp melt property and thus is advantageous from the viewpoint of securing low-temperature fixability of the toner as well as is advantageous from the viewpoint of easily taking a highly crystalline structure. As the crystalline resin, a conventionally known crystalline resin in the present technical field may be used together with the crystalline polyester resin, and examples of such a resin include a crystalline polyurethane resin, a crystalline polyurea resin, a crystalline polyamide resin, a crystalline polyether resin and the like. The “crystalline polyester resin” refers to a resin having a clear endothermic peak but not a stepwise endothermic change in the differential scanning calorimetry (DSC) among known polyester resins obtained by a polycondensation reaction of a di- or higher carboxylic acid (polycarboxylic acid) with a di- or higher alcohol (polyhydric alcohol). Specifically, a clear endothermic peak means a peak in which the half-value width of the endothermic peak is within 15° C. when the measurement is performed at a rate of temperature rise of 10° C./min in the differential scanning calorimetry (DSC). Incidentally, the crystalline resin other than the crystalline polyester resin also refers to a resin having a clear endothermic peak but not a stepwise endothermic change in DSC as described above.

A polycarboxylic acid is a compound containing two or more carboxy groups in one molecule. Specific examples thereof include saturated aliphatic dicarboxylic acids such as oxalic acid, malonic acid, succinic acid, suberic acid (octanedioic acid), adipic acid (hexanedioic acid), sebacic acid (decanedioic acid), azelaic acid, n-dodecylsuccinic acid, nonanedicarboxylic acid, decanedicarboxylic acid (dodecanedioic acid), undecanedicarboxylic acid, dodecanedicarboxylic acid, and tetradecanedicarboxylic acid; cycloaliphatic dicarboxylic acids such as cyclohexanedicarboxylic acid; aromatic dicarboxylic acids such as phthalic acid, isophthalic acid, and terephthalic acid; tri- or higher polycarboxylic acids such as trimellitic acid and pyromellitic acid; anhydrides or alkyl esters having 1 to 3 carbon atoms of these carboxylic acid compounds; and the like. One kind of these may be used singly, or two or more kinds thereof may be used in combination.

A polyhydric alcohol is a compound containing two or more hydroxy groups in one molecule. Specific examples thereof include aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, 1,12-dodecanediol, neopentyl glycol, and 1,4-butenediol; and tri- or higher polyhydric alcohols such as glycerin, pentaerythritol, trimethylolpropane, and sorbitol; and the like. One kind of these may be used singly, or two or more kinds thereof may be used in combination.

(Crystalline Polyester Resin)

The crystalline polyester resin in the toner of the present embodiment exhibits crystallinity and thus exhibits thermal melting property that a sharp decrease in viscosity is exhibited in the vicinity of the endothermic peak temperature. In other words, heat resistant storage stability due to crystallinity is favorable until immediately before the melting start temperature, and a sharp decrease in viscosity (sharp melt property) is caused at the melting start temperature to fix the toner, and it is thus possible to design toner exhibiting both favorable heat resistant storage stability and low-temperature fixability by using the crystalline polyester resin.

The crystalline polyester resin is preferably a crystalline polyester resin to be synthesized using a saturated aliphatic diol compound having 4 to 9 carbon atoms, particularly 1,4-butanediol, 1,6-hexanediol, 1,8-octanediol, 1,9-nonanediol, and derivatives thereof as a polyhydric alcohol component and a dicarboxylic acid having 6 to 12 carbon atoms, preferably a saturated dicarboxylic acid having 6 to 12 carbon atoms, particularly 1,6-hexanedioic acid, 1,8-octanedioic acid, 1,10-decanedioic acid, 1,12-dodecanedioic acid, and derivatives thereof as at least a polycarboxylic acid component.

In the present embodiment, it is preferable that the following relational expressions (1) and (2) are satisfied, where C_{alcohol} denotes the number of carbon atoms in the main chain of a structural unit derived from a polyhydric alcohol for forming the crystalline polyester resin and C_{acid} denotes the number of carbon atoms in the main chain of a structural unit derived from a polycarboxylic acid for forming the crystalline polyester resin.

[Math. 1]

6≤C_{acid}≤12 Relational expression (1):

4≤C_{alcohol}≤9 Relational expression (2):

When the C_{acid} in the relational expression (1) and the C_{alcohol} in the relational expression (2) are each equal to or less than the numerical value on the greater side, the crystalline polyester resin is hardly in a state of being incompatible with the binder resin (particularly amorphous resin), and thus the fixing effect is more likely to be attained. Moreover, it is preferable that the C_{acid} in the relational expression (1) and the C_{alcohol} in the relational expression (2) are each equal to or more than the numerical value on the smaller side since the spent suppressing effect is remarkable. Furthermore, it is more preferable that the following relational expressions (1a) and (2a) are satisfied since the low-temperature fixability is excellent, the spent suppressing effect is high, and the fogging suppressing effect is more remarkable.

[Math. 2]

8≤C_{acid}≤11 Relational expression (1a):

5≤C_{alcohol}≤8 Relational expression (2a):

Examples of the method for measuring and analyzing the number of carbon atoms C_{alcohol} in the main chain of a structural unit derived from a polyhydric alcohol and the number of carbon atoms C_{acid} in the main chain of a structural unit derived from a polycarboxylic acid include a method in which the toner or the toner base particles obtained after removing the external additive from the toner are decomposed by alkali hydrolysis and subjected to NMR measurement, methylation reaction Py-GC./MS measurement and the like.

With regard to the molecular weight of the crystalline polyester resin, those having a sharp molecular weight distribution and a low molecular weight are preferable from the viewpoint that the low-temperature fixability is excellent and the heat resistant storage stability is improved by preventing the increase of low molecular weight components. As a result of intensive investigations by the present inventors, it is preferable that the peak position in the molecular weight distribution in which the horizontal axis represents log (M) and the vertical axis represents percentage by mass is in a range of 3.5 to 4.0, the half-value width of the peak is 1.5 or less, the weight average molecular weight (Mw) is 3000 to 30000, the number average molecular weight (Mn) is 1000 to 10000, and the polydispersity (Mw/Mn) is 1 to 10 in the molecular weight distribution by GPC of the soluble components in o-dichlorobenzene. It is more preferable that the weight average molecular weight (Mw) is 5000 to 15000, the number average molecular weight (Mn) is 2000 to 10000, and the polydispersity (Mw/Mn) is 1 to 5 from the above viewpoint.

The proportion of the crystalline polyester resin contained is preferably in a range of 5% to 20% by mass with respect to the entire amount of the binder resin constituting the toner. Excellent low-temperature fixability is attained when the content of the crystalline polyester is 5% by mass or more. In addition, it is excellent that the content of the crystalline polyester resin is 20% by mass or less from the viewpoint of easily fabricating the toner. The content of the entire crystalline polyester resin is more preferably 6% to 15% by mass and particularly preferably 7% to 13% by mass with respect to the entire amount of the binder resin constituting the toner from this viewpoint.

In the present embodiment, the melting point of the crystalline polyester resin is a value to be measured as follows. In other words, the melting point is measured using a differential scanning calorimeter “Diamond DSC” (manufactured by PerkinElmer, Inc.) under the measurement conditions (temperature rise and cooling conditions) to pass through the first temperature raising process in which the temperature is raised from 0° C. to 200° C. at an elevating speed of 10° C./min, a cooling process in which the temperature is lowered from 200° C. to 0° C. at a cooling speed of 10° C./min, and the second temperature raising process in which the temperature is raised from 0° C. to 200° C. at an elevating speed of 10° C./min in this order. The endothermic peak top temperature derived from the crystalline polyester resin in the first temperature raising process is taken as the melting point (Tm) based on the DSC curve to be attained by this measurement. As a measurement method, 3.0 mg of a measurement sample is enclosed in an aluminum pan, the aluminum pan is set in a diamond DSC sample holder, and an empty aluminum pan is used as a reference. The melting points of other crystalline resins can also be measured in the same manner as described above.

The content of the entire crystalline resin is preferably 5% to 20% by mass with respect to the entire amount of the binder resin constituting the toner. One exhibiting excellent low-temperature fixability can be obtained when the content of the crystalline resin is 5% by mass or more. In addition, it is excellent that the content of the crystalline resin is 20% by mass or less from the viewpoint of easily fabricating the toner. The content of the entire crystalline resin is more preferably 6% to 15% by mass and particularly preferably 7% to 13% by mass with respect to the entire amount of the binder resin constituting the toner from this viewpoint.

[Amorphous Resin]

The amorphous resin to be contained in the toner of the present invention constitutes a binder resin together with the crystalline resin. An amorphous resin is a resin which does not have a melting point but has a relatively high glass transition temperature (Tg) when the resin is subjected to differential scanning calorimetry (DSC).

In the DSC measurement, when the glass transition temperature in the first temperature raising process is denoted as Tg₁ and the glass transition temperature in the second temperature raising process is denoted as Tg₂, Tg₁ of the amorphous resin is preferably 35° C. to 80° C. and more preferably 45° C. to 65° C. from the viewpoint of reliably attaining fixing properties such as low-temperature fixability and heat resistance such as heat resistant storage stability and blocking resistance. In addition, the Tg₂ of the amorphous resin is preferably 20° C. to 70° C. and more preferably 30° C. to 55° C. from the same viewpoint as described above.

The content of the amorphous resin is not particularly limited, but it is preferably 80% to 95% by mass with respect to the entire amount of the binder resin constituting the toner from the viewpoint of image strength. Furthermore, the content of the amorphous resin is more preferably 85% to 94% by mass and particularly preferably 87% to 93% by mass with respect to the entire amount of the binder resin constituting the toner. Incidentally, in the case of containing two or more kinds of resins as the amorphous resin, the total amount thereof is preferably in the above content range with respect to the entire amount of the binder resin constituting the toner. Incidentally, in the case of using an amorphous resin containing a release agent, the content of the release agent in the amorphous resin is not included in the content of the amorphous resin.

The amorphous resin to be used in the toner base particles according to the present embodiment is not particularly limited, amorphous resins conventionally known in the present technical field are used, and examples thereof include amorphous polyester resins, amorphous vinyl resins and the like.

(Amorphous Polyester Resin)

An amorphous polyester resin is obtained by a polycondensation reaction of a di- or higher carboxylic acid (polycarboxylic acid) with a di- or higher alcohol (polyhydric alcohol). The specific amorphous polyester resin is not particularly limited, and amorphous polyester resins conventionally known in the present technical field can be used.

The specific production method of the amorphous polyester resin is not particularly limited, and examples thereof include a method in which a polycarboxylic acid and a polyhydric alcohol are polycondensed (esterified) using a known esterification catalyst.

<<Polycarboxylic Acid>>

Examples of the polycarboxylic acid include aromatic carboxylic acids such as terephthalic acid, isophthalic acid, phthalic anhydride, trimellitic anhydride, pyromellitic acid, and naphthalenedicarboxylic acid, aliphatic carboxylic acids such as maleic anhydride, fumaric acid, succinic acid, alkenylsuccinic anhydride, and adipic acid, and alicyclic carboxylic acids such as cyclohexanedicarboxylic acid. One kind or two or more kinds of these polycarboxylic acids can be used. Among these polycarboxylic acids, it is preferable to use an aromatic carboxylic acid. In addition, it is preferable to use a tri- or higher carboxylic acid capable of taking a crosslinked structure or a branched structure together with a dicarboxylic acid from the viewpoint of securing more favorable fixing properties.

Examples of the tri- or higher carboxylic acids include 1,2,3-benzenetricarboxylic acid, 1,2,4-benzenetricarboxylic acid (trimellitic acid), 1,3,5-benzenetricarboxylic acid, 1,2,4-naphthalenetricarboxylic acid, anhydrides thereof, lower alkyl esters thereof, and the like. These may be used singly or two or more kinds thereof may be used concurrently.

<<Polyhydric Alcohol>>

Examples of the polyhydric alcohols include aliphatic diols such as ethylene glycol, diethylene glycol, triethylene glycol, propylene glycol, butanediol, hexanediol, neopentyl glycol, and glycerin, cycloaliphatic diols such as cyclohexanediol, cyclohexanedimethanol, and hydrogenated bisphenol A, and aromatic diols such as an ethylene oxide adduct of bisphenol A and a propylene oxide adduct of bisphenol A. These polyhydric alcohols may be used singly or two or more kinds thereof may be used in combination. Among these polyhydric alcohols, aromatic diols and alicyclic diols are preferable and aromatic diols are more preferable. In addition, tri- or higher polyhydric alcohols (glycerin, trimethylolpropane, pentaerythritol and the like) which can be a crosslinked structure or a branched structure may be concurrently used with the diols from the viewpoint of securing more favorable fixing properties.

Incidentally, the acid value of the amorphous polyester resin may be adjusted by further adding a monocarboxylic acid and/or a monoalcohol to the amorphous polyester resin obtained by polycondensation of a polycarboxylic acid with a polyhydric alcohol and thus esterifying the hydroxy group and/or carboxy group at the polymerization terminal.

Examples of the monocarboxylic acid include acetic acid, acetic anhydride, benzoic acid, trichloroacetic acid, trifluoroacetic acid, propionic anhydride and the like. In addition, the monoalcohol is not particularly limited, and examples thereof include methanol, ethanol, propanol, octanol, 2-ethylhexanol, trifluoroethanol, trichloroethanol, hexafluoroisopropanol, phenol and the like.

As the amorphous polyester resin, a resin obtained by modifying the above-mentioned amorphous polyester resin to form a binder resin precursor (modified polyester resin) and extending or crosslinking the binder resin precursor (modified polyester resin) is more preferable.

(Binder Resin Precursor)

As the binder resin precursor, a binder resin precursor composed of a modified polyester resin is preferable, and examples thereof include polyester prepolymers modified with isocyanates, epoxy, and the like. It is effective to subject the binder resin precursor to an extension reaction or a crosslinking reaction with a compound (amines or the like) having an active hydrogen group as a compound which extends or crosslinks for increasing the difference between the minimum fixing temperature and the hot offset occurring temperature. By performing an extension (crosslinking) reaction and thus partially obtaining those having a high molecular weight, it is possible to maintain elasticity even at a high temperature and to avoid hot offset which occurs due to toner tearing at a high temperature. The high molecular weight body does not greatly affect the low-temperature fixing since the amount thereof is small. For this reason, it is considered that the temperature region in which the toner can be released from the fixing belt is widened and this leads to an increase in the difference between the minimum fixing temperature and the hot offset occurring temperature. Furthermore, it is possible to eliminate the particle interface of the emulsion aggregation type toner base particles by subjecting the binder resin precursor (the prepolymer) to an extension reaction or a crosslinking reaction with a compound having an active hydrogen group and thus fabricating toner base particles. The toner containing the toner base particles obtained in this manner is more hardly crushed and is advantageous with respect to spent, and the spent suppressing effect is remarkable.

The polyester prepolymer can be easily synthesized by reacting a polyester resin to be a base with a conventionally known isocyanate forming agent, an epoxidizing agent, and the like.

Examples of the isocyanate forming agent include aliphatic polyisocyanates (tetramethylene diisocyanate, hexamethylene diisocyanate, 2,6-diisocyanatomethylcaproate and the like); alicyclic polyisocyanates (isophorone diisocyanate, cyclohexylmethane diisocyanate and the like); aromatic diisocyanates (tolylene diisocyanate, diphenylmethane diisocyanate and the like); araliphatic diisocyanates (α,α,α′,α′-tetramethylxylylene diisocyanate and the like); isocyanurates; those obtained by blocking the polyisocyanate with a phenol derivative, oxime, caprolactam and the like; and concurrent use of two or more kinds of these.

Moreover, representative examples of the epoxidizing agent include epichlorohydrin and the like.

With regard to the ratio of the isocyanate forming agent, the ratio [NCO]/[OH] of the equivalent of the isocyanate group [NCO] in the isocyanate forming agent to the equivalent of the hydroxy group [OH] in the polyester resin to be a base is usually 5/1 to 1/1, preferably 4/1 to 1.2/1, and more preferably 2.5/1 to 1.5/1. The low-temperature fixability is further improved when [NCO]/[OH] is 5 or less. When the molar ratio of [NCO] is 1 or more, a decrease in the urea content in the polyester prepolymer can be prevented and thus the hot offset resistance is improved.

The content of the isocyanate forming agent in the polyester prepolymer is usually 0.5% to 40% by mass, preferably 1% to 30% by mass, and more preferably 2% to 20% by mass. When the content is 0.5% by mass or more, it is more advantageous from the perspective of both heat resistant storage stability and low-temperature fixability as well as the hot offset resistance is improved. In addition, the low-temperature fixability is improved when the content is 40% by mass or less.

In addition, the number of isocyanate groups per one molecule in the polyester prepolymer is usually 1 or more, preferably 1.5 to 3 on average, and still more preferably 1.8 to 2.5 on average. When the number of isocyanate groups is one or more per one molecule, a decrease in the molecular weight of the urea-modified polyester resin after the extension reaction can be prevented and thus the hot offset resistance is improved.

The binder resin precursor preferably has a weight average molecular weight of 1×10⁴ or more and 3×10⁵ or less.

(Compound which Extends or Crosslinks Binder Resin Precursor)

Examples of the compound which extends or crosslinks the binder resin precursor include compounds having an active hydrogen group, and representative examples thereof include amines.

Examples of the amines include diamine compounds, tri- or higher polyamine compounds, amino alcohol compounds, amino mercaptan compounds, amino acid compounds, and compounds obtained by blocking the amino groups in these, and the like.

Examples of the diamine compounds include aromatic diamines (phenylenediamine, diethyltoluenediamine, 4,4′diaminodiphenylmethane and the like); cycloaliphatic diamines (4,4′-diamino-3,3′dimethyldicyclohexylmethane, diaminecyclohexane, isophoronediamine and the like); aliphatic diamines (ethylenediamine, tetramethylenediamine, hexamethylenediamine and the like); and the like.

Examples of the tri- or higher polyamine compounds include diethylenetriamine, triethylenetetramine and the like.

Examples of the amino alcohol compounds include ethanolamine, hydroxyethylaniline and the like.

Examples of the aminomercaptan compounds include aminoethylmercaptan, aminopropylmercaptan and the like.

Examples of the amino acid compounds include aminopropionic acid, aminocaproic acid and the like.

Examples of the compounds obtained by blocking the amino groups in these include ketimine compounds obtained from the amines and ketones (acetone, methyl ethyl ketone, methyl isobutyl ketone and the like), oxazoline compounds and the like. Among these amines, preferred ones are a diamine compound and a mixture of a diamine compound with a small amount of a polyamine compound.

In the present invention, it is preferable to use an amorphous unmodified polyester resin as the binder resin.

It is preferable that at least a part of the modified polyester resin obtained by crosslinking and/or extension reaction of a binder resin precursor composed of a modified polyester-based resin and the unmodified polyester resin are compatible. This makes it possible to improve the low-temperature fixability and hot offset resistance.

For this reason, it is preferable that the polyhydric alcohol and polycarboxylic acid to be used in the modified polyester resin and the polyhydric alcohol and polyhydric carboxylic acid to be used in the unmodified polyester resin have similar compositions.

In addition, the unmodified polyester resin may be a crystalline polyester resin or an amorphous polyester resin.

The endothermic shoulder temperature (T2-ns1) of the unmodified polyester resin is preferably 45° C. or more and less than 65° C. and still more preferably 45° C. or more and less than 55° C. It is preferable that the endothermic shoulder temperature is 45° C. or more since the heat resistant storage stability of the toner is improved. It is preferable that the endothermic shoulder temperature is less than 65° C. since the low-temperature fixability of the toner is improved.

The acid value of the unmodified polyester resin is preferably 1 to 50 mg KOH/g and more preferably 5 to 30 mg KOH/g. When the acid value of the unmodified polyester resin is 1 mg KOH/g or more, the toner is likely to be negatively charged, further, the affinity of the toner for the paper is improved at the time of fixing to paper, and the low-temperature fixability can be improved. It is preferable that the acid value of the unmodified polyester resin is 50 mg KOH/g or less since charging stability, particularly charging stability with respect to the environmental fluctuations is improved.

The hydroxyl value of the unmodified polyester resin is preferably 5 mg KOH/g or more.

The hydroxyl value is measured using a method conforming to JIS K0070-1992.

Specifically, 0.5 g of a sample is first precisely weighed in a 100 ml volumetric flask, and 5 ml of an acetylating reagent is added to this.

Next, heating is performed in a warm bath at 100±5° C. for 1 to 2 hours, and then the flask is removed from the warm bath and left to cool. Furthermore, acetic anhydride is decomposed by adding water thereto and shaking the mixture.

Next, in order to completely decompose acetic anhydride, the flask is heated again in a warm bath for 10 minutes or more and left to cool, and then the wall of the flask is thoroughly washed with an organic solvent.

Furthermore, using a potentiometric automatic titrator DL-53 Titrator (manufactured by METTLER TOLEDO) and an electrode DG113-SC (manufactured by METTLER TOLEDO), the hydroxyl value is measured at 23° C. and analyzed using analysis software LabX Light Version 1.00.000. Incidentally, a mixed solvent of 120 ml of toluene and 30 ml of ethanol is used for calibration of the apparatus.

At this time, the measurement conditions are as follows.

Stir

| | |
|---|---|
| Speed[%] | 25 |
| Time[s] | 15 |

EQP titration
Titrant/Sensor

| | |
|---|---|
| Titrant | CH₃ONa |
| Concentration[mol/L] | 0.1 |
| Sensor | DG115 |
| Unit of measurement | mV |

Predispensing to volume

| | |
|---|---|
| Volume[mL] | 1.0 |
| Wait time[s] | 0 |

Titrant addition Dynamic

| | |
|---|---|
| dE(set)[mV] | 8.0 |
| dV(min)[mL] | 0.03 |
| dV(max)[mL] | 0.5 |

Measure mode Equilibrium controlled

| | |
|---|---|
| dE[mV] | 0.5 |
| dt[s] | 1.0 |
| t(min)[s] | 2.0 |
| t(max)[s] | 20.0 |

Recognition

| | |
|---|---|
| Threshold | 100.0 |
| Steepest jump only | No |
| Range | No |
| Tendency | None |

Termination

| | |
|---|---|
| at maximum volume[mL] | 10.0 |
| at potential | No |
| at slope | No |
| after number EQPs n = 1 | Yes |
| comb. termination conditions | No |

Evaluation

| | |
|---|---|
| Procedure | Standard |
| Potential1 | No |
| Potential2 | No |
| Stop for reevaluation | No. |

In a case in which the toner composition to be described later contains a modified polyester resin such as a urea-modified polyester resin, the modified polyester resin can be produced by a one-shot method and the like.

As an example of the modified polyester resin, a method for producing a urea-modified polyester resin will be described.

First, a polyol and a polycarboxylic acid are heated to 150° C. to 280° C. in the presence of a catalyst such as tetrabutoxy titanate or dibutyl tin oxide and, if necessary, the water to be generated is removed while lowering the pressure to obtain a polyester resin having a hydroxy group.

Next, the polyester resin having a hydroxy group is reacted with polyisocyanate at 40° C. to 140° C. to obtain a polyester prepolymer having an isocyanate group.

Furthermore, a polyester prepolymer having an isocyanate group is reacted with amines at 0° C. to 140° C. to obtain a urea-modified polyester resin.

The number average molecular weight of the urea-modified polyester resin is usually 1000 to 10000 and preferably 1500 to 6000.

Incidentally, in the case of reacting the polyester resin having a hydroxy group with polyisocyanate and the case of reacting the polyester prepolymer having an isocyanate group with amines, a solvent can be used if necessary.

Examples of the solvent include those inert with respect to isocyanate groups such as aromatics (toluene, xylene and the like); ketones (acetone, methyl ethyl ketone, methyl isobutyl ketone and the like); esters (ethyl acetate and the like);amides (dimethylformamide, dimethylacetamide and the like); and ethers (tetrahydrofuran and the like).

Incidentally, in the case of concurrently using an unmodified polyester resin, the unmodified polyester resin may be mixed in the solution obtained after the reaction of urea-modified polyester resin.

In addition, the urea-modified polyester resin can be concurrently used with a polyester resin modified with a chemical bond other than a urea bond, for example, a polyester resin modified with a urethane bond other than an unmodified polyester resin.

In the present invention, as the binder resin component, a crystalline polyester resin, an amorphous polyester resin, a binder resin precursor, and an unmodified resin may be concurrently used, but binder resin components other than these resins may be contained.

As the binder resin component, it is preferable to contain a polyester resin and it is still more preferable to contain a polyester resin at 50% by mass or more. This is because the low-temperature fixability is improved when the content of polyester resin is 50% by mass or more. It is particularly preferable that all the binder resin components are polyester resins. In the present invention, a crystalline polyester resin is essentially contained since the low-temperature fixability is particularly excellent.

Incidentally, examples of the binder resin component other than the polyester resin include polymers of styrene or styrene-substituted products such as polystyrene, poly(p-chlorostyrene), and polyvinyl toluene; styrene-based copolymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-a-chloromethyl methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer; polymethyl methacrylate, polybutyl methacrylate, polyvinyl chloride, polyvinyl acetate, polyethylene, polypropylene, epoxy resin, epoxy polyol resin, polyurethane resin, polyamide resin, polyvinyl butyral, polyacrylic acid resin, rosin, modified rosin, terpene resin, aliphatic or alicyclic hydrocarbon resin, aromatic petroleum resin, chlorinated paraffin, paraffin wax and the like.

(Blending Ratio of Both Polyester Resins)

As the blending ratio (mass ratio) of the crystalline polyester resin to the amorphous polyester resin in the present invention, it is preferable that the proportion of amorphous polyester resin is 55% by mass to 97% by mass and the proportion of crystalline polyester resin is preferably 3% by mass to 45% by mass and it is more preferable that the proportion of amorphous polyester resin is 80% by mass to 95% by mass and the proportion of crystalline polyester resin is 5% by mass to 20% by mass with respect to 100% by mass of the sum of the crystalline polyester resin and the amorphous polyester resin. The low-temperature fixability is excellent when the amount of the crystalline polyester resin is 3% by mass or more, and the fixing offset resistance and the heat-resistant storage stability are excellent when the amount of the crystalline polyester resin is 45% by mass or less.

(Amorphous Vinyl Resin)

The amorphous resin may contain an amorphous vinyl resin. The amorphous vinyl resin is not particularly limited as long as it is one obtained by polymerizing a vinyl compound, but examples thereof include (meth)acrylic acid ester resin, styrene-(meth)acrylic acid ester resin, ethylene-vinyl acetate resin and the like. One kind of these may be used singly, or two or more kinds thereof may be used in combination.

Among the above amorphous vinyl resins, styrene-(meth)acrylic acid ester resin is preferable in consideration of plasticity at the time of heat fixing. In addition, styrene-(meth)acrylic acid ester resin is preferable from the viewpoint that the negative chargeability as a toner is likely to be maintained. In addition, styrene-(meth)acrylic acid ester resin is preferable from the viewpoint that the negative chargeability is enhanced as the toner is fabricated using the styrene-(meth)acrylic acid ester resin by an emulsion aggregation method. Hence, the styrene-(meth)acrylic acid ester resin (hereinafter also referred to as “styrene-(meth)acrylic resin”) as an amorphous resin will be hereinafter described below.

The styrene-(meth)acrylic resin is formed by addition polymerization of at least a styrene monomer and a (meth)acrylic acid ester monomer. The styrene monomer mentioned here includes those having a structure having a known side chain or functional group in the styrene structure in addition to styrene represented by a structural formula of CH₂═CH—C₆H₅.

In addition, the (meth)acrylic acid ester monomer mentioned here are those containing an ester having a known side chain or functional group in the structure of an acrylic acid ester derivative, a methacrylic acid ester derivative or the like in addition to acrylic acid esters and methacrylic acid esters represented by CH₂═CHCOOR (R denotes an alkyl group). Incidentally, in the present specification, “(meth)acrylic acid ester monomer” is a general term for an “acrylic acid ester monomer” and a “methacrylic acid ester monomer”.

An example of the styrene monomer and (meth)acrylic acid ester monomer capable of forming the styrene-(meth)acrylic resin is presented below.

Specific examples of the styrene monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene, and the like. These styrene monomers can be used singly or in combination of two or more kinds thereof.

In addition, specific examples of the (meth)acrylic acid ester monomer include acrylic acid ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; methacrylic acid esters such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate; and the like. These (meth)acrylic acid ester monomers can be used singly or in combination of two or more kinds thereof.

The percentage content of a structural unit derived from the styrene monomer in the styrene-(meth)acrylic resin is preferably in a range of 40% to 90% by mass with respect to the entire amount of the resin. In addition, the percentage content of a structural unit derived from the (meth)acrylic acid ester monomer in the resin is preferably in a range of 10% to 60% by mass with respect to the entire amount of the resin. Furthermore, the styrene-(meth)acrylic resin may contain the following monomer compounds in addition to the styrene monomer and the (meth)acrylic acid ester monomer. Examples of such monomer compounds include compounds having a carboxy group such as acrylic acid, methacrylic acid, maleic acid, itaconic acid, cinnamic acid, fumaric acid, maleic acid monoalkyl ester, and itaconic acid monoalkyl ester; compounds having a hydroxy group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. These monomer compounds can be used singly or in combination of two or more kinds thereof.

The percentage content of structural units derived from the monomer compounds in the styrene-(meth)acrylic resin is preferably in a range of 0.5% to 20% by mass with respect to the entire amount of the resin.

<Other Constituents (Internal Additives)>

The toner to be used in the present invention may contain internal additives such as a colorant, a release agent (wax), and a charge control agent in the toner base particles in addition to the binder resin containing a crystalline polyester resin.

<Colorant>

As the colorant contained in the toner of the present invention, known inorganic or organic colorants can be used. As the colorant, various known organic and inorganic dyes and pigments can be all used in addition to carbon black and magnetic powder. As such colorants, it is possible to use, for example, Carbon Black, Nigrosine Dye, Iron Black, Naphthol Yellow S, Hansa Yellow (10G, 5G, G), Cadmium Yellow, Yellow Iron Oxide, Ocher, Yellow Lead, Titanium Yellow, Polyazo Yellow, Oil Yellow, Hansa Yellow (GR, A, RN, R), Pigment Yellow L, Benzidine Yellow (G, GR), Permanent Yellow (NCG), Vulcan (registered trademark) Fast yellow (5G, R), Tartrazine Lake, Quinoline Yellow Lake, Anthracene Yellow BGL, Isoindolinone Yellow, Bengala, Minium, Red Lead, Cadmium Red, Cadmium Mercury Red, Antimony Red, Permanent Red 4R, Para Red, Phiise Red, Para Chloro Ortho Nitro Aniline Red, Resol Fast Scarlet G, Brilliant Fast Scarlet, Brilliant Carmine BS, Permanent Red (F2R, F4R, FRL, FRLL, F4RH), Fast Scarlet V D, Belkan Fast Rubin B, Brilliant Scarlet G, Resol Rubin G X, Permanent Red FSR, Brilliant Carmine 6B, Pigment Scarlet 3B, Bordeaux 5B, Torujin Maroon, Permanent Bordeaux F2K, Helio Bordeaux B L, Bordeaux 10B, Bon Maroon Light, Bon Maroon Medium, Eosin Lake, Rhodamine Lake B, Rhodamine Lake Y, Alizarin Lake, Thioindigo Red B, Thioindigo Maroon, Oil Red, Quinacridone Red, Pyrazolone Red, Polyazo Red, Chrome Vermilion, Benzidine Orange, Perinone Orange, Oil Orange, Cobalt Blue, Cerulean Blue, Alkaline Blue Lake, Peacock Blue Lake, Victoria Blue Lake, Metal-free Phthalocyanine Blue, Phthalocyanine Blue, Fast Sky Blue, Indanthrene Blue (RS, BC), Indigo, Ultramarine Blue, Bituminous, Anthraquinone Blue, Fast Violet B, Methyl Violet Lake, Cobalt Purple, Manganese Purple, Dioxane Violet, Anthraquinone Violet, Chrome Green, Zinc Green, Chrome Oxide, Pyridiane, Emerald Green, Pigment Green B, Naphthol Green B, Green Gold, Acid Green Lake, Malachite Green Lake, Phthalocyanine Green, Anthraquinone Green, Titanium Oxide, Zinc White, Lithopone, and mixtures thereof.

The content of the colorant is usually 1% to 15% by mass and preferably 3% to 10% by mass with respect to the amount of the toner base particles. Color reproducibility of the image can be secured when the content of the colorant is in such a range.

In addition, the size of the colorant is preferably 10 to 1000 nm, more preferably 50 to 500 nm, and particularly preferably 80 to 300 nm in terms of volume average particle diameter (volume-based median diameter). The volume average particle diameter may be a catalog value or a value measured using “UPA-150” (manufactured by MicrotracBEL Corp.).

The colorant to be used in the present invention can also be used as a master batch compounded with a resin.

Examples of the binder resin to be used in the production of the master batch or kneaded together with the master batch include polymers of styrene and substituted products thereof such as polystyrene, poly-p-chlorostyrene, and polyvinyltoluene; styrene-based polymers such as styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-a-chloromethyl methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, and styrene-maleic acid ester copolymer; polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, paraffin wax and the like in addition to the modified and unmodified polyester resins which have been previously mentioned. These can be used singly or in mixture.

This master batch can be obtained by mixing and kneading a resin for master batch and a colorant by applying a high shear force to the mixture. At this time, an organic solvent can be used to enhance the interaction between the colorant and the resin.

In addition, a so-called flushing method in which an aqueous paste containing water of colorant is mixed and kneaded together with a resin and an organic solvent and the colorant is transferred to the resin side to remove the moisture and organic solvent components is also preferably used. This is because the wet cake of colorant can be used as it is and the wet cake is not required to be dried in this method. In the above mixing and kneading, a high shear dispersion apparatus such as a three-roll mil is preferably used.

<Release Agent>

The toner according to the present invention can contain a release agent. The release agent is preferably wax having a melting point of 50° C. to 120° C.

Such wax can effectively act as a release agent between the fixing roller and the toner interface, and thus high temperature offset resistance can be improved without coating the fixing roller with a release agent such as oil.

Incidentally, the melting point of the wax is determined by measuring the highest endothermic peak using a differential scanning calorimeter (for example, TG-DSC system TAS-100 and the like manufactured by Rigaku Corporation).

As the release agent, the materials to be presented below can be used.

Examples of waxes include plant waxes such as carnauba wax, cotton wax, wood wax, and rice wax; animal waxes such as beeswax and lanolin; mineral waxes such as ozokerite and cercin; petroleum waxes such as paraffin, microcrystalline, and petrolatum, and the like.

In addition, examples of release agents other than these natural waxes include synthetic hydrocarbon waxes such as Fischer-Tropsch wax and polyethylene wax; synthetic waxes such as esters, ketones, and ethers; and the like.

Furthermore, fatty acid amides such as 1,2-hydroxystearic amide, stearic amide, phthalic anhydride imide, chlorinated hydrocarbons and the like; and a crystalline polymer which is a crystalline polymer having a low molecular weight and has a long-chain alkyl group in the side chain of a homopolymer or copolymer (for example, n-stearyl acrylate-ethyl methacrylate copolymer) of polyacrylates such as poly(n-stearyl methacrylate), poly(n-lauryl methacrylate), and the like can also be used as a release agent.

The content of the release agent in the toner is preferably in a range of 2% to 30% by mass and more preferably in a range of 5% to 20% by mass with respect to the entire mass of the toner base particles.

<Charge Control Agent>

In addition, a charge control agent may be contained (internally added) in the toner according to the present invention, if necessary.

As the charge control agent, known ones can be all used, and the known charge control agents are, for example, nigrosine-based dyes, triphenylmethane-based dyes, chromium-containing metal complex dyes, molybdate chelate pigments, rhodamine-based dyes, alkoxy-based amines, quaternary ammonium salts (including fluorine-modified quaternary ammonium salts), alkylamides, phosphorus simple substance or compounds, tungsten simple substance or compounds, fluorine-based activators, salicylic acid metal salts, salicylic acid metal complexes, metal salts of salicylic acid derivatives, and the like.

Specific examples thereof include Bontron 03 of a nigrosine-based dye, Bontron (registered trademark, the same applies hereinafter) P-51 of a quaternary ammonium salt, Bontron S-34 of a metal-containing azo dye, E-82 of an oxynaphthoic acid-based metal complex, E-84 of a salicylic acid metal complex, and E-89 of a phenolic condensate (all manufactured by Orient Chemical Industries Co., Ltd.), TP-302 and TP-415 of quaternary ammonium salt molybdenum complexes (all manufactured by Hodogaya Chemical Co., Ltd.), COPY CHARGE PSY VP2038 of a quaternary ammonium salt, COPY BLUE PR of a triphenylmethane derivative, and COPY CHARGE NEG VP2036 and COPY CHARGE NX VP434 of quaternary ammonium salts (all manufactured by Hoechst A G), LRA-901 and LR-147 of a boron complex (all manufactured by Nippon Carlit Co., Ltd.), copper phthalocyanine, perylene, quinacridone, azo-based pigments, and high molecular compounds having functional groups such as a sulfonic acid group, a carboxy group, and a quaternary ammonium salt.

The content of the charge control agent is determined by the kind of binder resin (binder resin), the presence or absence of additives to be used if necessary, and the toner producing method including a dispersion method and is not definitively limited but is preferably used in a range of 0.1 to 10 parts by mass with respect to 100 parts by mass of the binder resin (binder resin). A range of 0.2 to 5 parts by mass is preferable. When the content of the charge control agent is 10 parts by mass or less, the chargeability of the toner does not increase too much but it is possible to further improve the effect of the charge control agent, to suppress an increase in electrostatic attraction force with the developing roller, to prevent a decrease in the fluidity of the developer, and to prevent a decrease in the image density.

These charge control agents can also be dissolved and dispersed after being melted and kneaded together with a masterbatch and a resin, may be directly dissolved in an organic solvent and added when dispersing is performed, or may be immobilized on the surface of the toner base particles after fabrication of the toner base particles.

[Form of Toner Base Particles]

The form of the toner base particles according to the present invention is not particularly limited and, for example, may be a so-called single layer structure (a homogeneous structure which is not a core-shell type), may be a core-shell structure, or may be a multilayer structure composed of three or more layers.

[Volume-Based Median Diameter of Toner Base Particles]

The particle diameter of the toner base particles constituting the toner of the present invention is preferably 2 to 8 μm and more preferably 3 to 6 μm as a volume-based median diameter. It is excellent that the volume-based median diameter of the toner base particles is 2 μm or more from the viewpoint that sufficient fluidity can be maintained. In addition, it is excellent that the volume-based median diameter of the toner base particles is 8 μm or less from the viewpoint that high image quality can be maintained. Moreover, as the volume-based median diameter of the toner base particles is in the above range, the transfer efficiency increases, the image quality of halftone is improved, and the image quality of fine lines, dots, and the like is improved.

<Method for Measuring Volume-Based Median Diameter of Toner Base Particles>

The volume-based median diameter of the toner base particles is measured and calculated using a measuring apparatus in which a computer system equipped with data processing software “Software V3.51” is connected to “Coulter Multisizer 3” (manufactured by Beckman Coulter, Inc.). Specifically, 0.02 g of a measurement sample (toner) is added to and mixed with 20 mL of a surfactant solution (for example, a surfactant solution prepared by diluting a neutral detergent containing a surfactant component with pure water 10 times for the purpose of dispersing the toner particles). Thereafter, ultrasonic dispersion is performed for 1 minute to prepare a toner dispersion, this toner dispersion is injected into a beaker containing “ISOTON II” (manufactured by Beckman Coulter, Inc.) in a sample stand using a pipette until the display density by the measuring apparatus reaches 8%. Here, a reproducible measurement value can be attained by setting the concentration to this concentration range. Thereafter, the number of counts of the measurement particles is set to 25000 and the aperture diameter is set to 100 μm in the measuring apparatus, the frequency values are calculated by dividing the measurement range of 2 to 60 μm into 256, and the particle diameter at 50% from the larger cumulative volume fraction is taken as the volume-based median diameter.

In addition, the value of volume-based median diameter of the toner base particles can also be measured by performing a separation treatment of the external additive from the toner sample to which the external additive is attached and using the resultant toner sample as a sample. In this case, the external additive is separated by the following method.

Specifically, 4 g of toner is wetted with 40 g of a 0.2% by mass aqueous solution of polyoxyethyl phenyl ether, and the ultrasonic energy is adjusted so that the value by the ammeter attached to the main unit for indicating the vibration instruction value is 60 μA (50 W) and applied for 30 minutes using an ultrasonic homogenizer (for example, US-1200T manufactured by Nippon Seiki Co., Ltd.; specification frequency: 15 kHz). Thereafter, the external additive is washed away using a membrane filter having a pore diameter of 1 μm, and the toner components on the filter are used as the measurement target.

<<External Additive of Toner>>

The toner according to the present embodiment contains an external additive on the surface of the toner base particles from the viewpoint of controlling the fluidity, chargeability, and the like of the toner. Such an external additive is added to the surface of the toner base particles. In the present embodiment, alumina particles are contained as an external additive. Here, as alumina having higher Mohs hardness than other external additives is used as the external additive, alumina is likely to be buried in the toner base particles because of the difference in hardness from the toner base particles, the adhesive strength increases, and the detachment of the external additive in the developing machine is suppressed. In addition, alumina has a high thermal conductivity and thus an increase in the temperature of the developer can be suppressed and softening of the toner can also be suppressed. As a result, the adhesive force of the toner can be sufficiently diminished in the developing machine as well and spent is suppressed. In addition, the alumina external additive is hardly detached in the developing machine as well, thus the charging stability is also enhanced and the fogging is also suppressed. Furthermore, the alumina external additive hardly inhibits heat conduction to the toner base particles at the time of fixing, it is thus possible to maintain low-temperature fixability, to suppress spent of the toner on the carrier, to suppress fogging, and to attain the above-described effects.

(Alumina Particles)

Alumina constituting the alumina particles refers to aluminum oxide represented by Al₂O₃, and forms such as α-type, γ-type, σ-type, and mixtures thereof are known. The shape of the alumina particles ranges from a cubic shape to a spherical shape depending on the control of crystal system. The alumina particles can be fabricated by a known method. As a method for fabricating alumina particles, the Bayer process is common, but examples of a fabrication method for obtaining highly pure and nano-sized alumina particles include a hydrolysis method, a gas phase synthesis method, a flame hydrolysis method, an underwater spark discharge method, and the like.

As a method for analyzing the material of specific particles (for example, alumina particles) such as external additive particles, the material of the external additive particles such as alumina can be identified, for example, by increasing the acceleration voltage to 20 keV by EDS (energy dispersive X-ray spectroscopy and analysis) and confirming the elements of the external additive particles after being separated from the toner. This analysis method can also be applied to the material (alumina, indium, tin, and the like) of alumina-containing particles which are contained in the resin layer of the carrier to be described later.

The number average primary particle diameter of the alumina particles is preferably in a range of 10 nm or more and 40 nm or less. When the number average primary particle diameter of the alumina particles is 10 nm or more, the alumina particles which are an external additive are not buried too much in the toner base particles, the effect of decreasing the adhesive force increases, and as a result, the spent suppressing effect is more likely to be attained. In addition, when the number average primary particle diameter of the alumina particles is 40 nm or less, the alumina particles which are an external additive are hardly detached and the spent suppressing effect is more likely to be attained. The number average primary particle diameter of the alumina particles is more preferably in a range of 13 nm or more and 25 nm or less from the viewpoint that the spent suppressing effect is more likely to be attained. Incidentally, the number average primary particle diameter of the alumina particles of an external additive is the number average primary particle diameter of the alumina particles after being subjected to the surface modification in the case of surface-modified alumina particles to be described below.

(Method for Measuring Number Average Primary Particle Diameter)

As the method for measuring the number average primary particle diameter of specific particles (for example, alumina particles) such as external additive particles, the photographic image taken using a scanning electron microscope (SEM) “JSM-7401F” (manufactured by JEOL Ltd.) is captured with a scanner and specific particles such as external additive particles in the photographic image are binarized using an image processing analyzer LUZEX AP (manufactured by NIRECO CORPORATION). Thereafter, the horizontal ferret diameter is calculated for 100 specific particles such as external additive particles, and the average value thereof is taken as the number average primary particle diameter of the specific particles.

(External additive: surface modification of alumina particles)

The surface of alumina particles essential as an external additive may be modified with a surface modifier. It can be said that it is preferable to subject the alumina particles to surface modification in order to secure a dispersed state on the toner base particles and to improve the fluidity as the toner after the external addition. The surface-modified alumina particles have alumina particles and a surface modifier residue disposed on the surface of the alumina particles. The surface modifier includes a reaction moiety which reacts with the hydroxy groups on the surface of the alumina particles and a nonreaction moiety which does not react with the hydroxy groups on the surface of the alumina particles. As the surface of the alumina particles is modified with a surface modifier, the surface modifier residue is disposed on the surface of the alumina particles. The surface modifier residue is generally an organic group. The structure of the surface modifier residue can be selected depending on the surface modifier to be selected. Examples of the surface modifier residue include an alkyl group, an aryl group, and an alkoxy group.

Examples of the surface modifier include a silazane represented by the following Formula (A) and a silane coupling agent represented by the following Formula (B).

[Chem. 1]

(R¹, R², R³)—Si—NH—Si—(R¹, R², R³) Formula (A)

(R⁴)₄₋ₙ—Si—(OR⁵)ₙ Formula (B)

In Formulas (A) and (B), R¹ to R⁴ each independently denote a hydrogen atom, an alkyl group which may have a substituent, an aryl group which may have a substituent, or an alkoxy group which may have a substituent. R⁵s each independently denote a hydrogen atom, an alkyl group which may have a substituent, or an aryl group which may have a substituent. R¹ to R⁵ may be the same as or different from one another. n denotes an integer 1 to 4.

As the silazane, known one can be used in the range in which the effect of the present embodiment is not impaired. The silazane is particularly preferably hexamethyldisilazane or hexaethyldisilazane from the viewpoint of suppressing aggregation of the external additive particles and from the viewpoint of reactivity with the surface of the external additive particles.

As the silane coupling agent, known one can be used in the range in which the present embodiment is not inhibited. The silane coupling agent preferably contains a linear alkyl group having 1 to 12 carbon atoms. The linear alkyl group may have a substituent. In Formula (B) above, as IV denotes an alkyl group having 1 to 12 carbon atoms, the external additives have an appropriate intermolecular force due to the interaction between the alkyl groups and the aggregation thereof can be suppressed. The number of carbon atoms in R⁴ is more preferably 4 to 8. It is preferable that the number of carbon atoms in R⁴ is 12 or less from the viewpoint that the enhancement of aggregability can be effectively suppressed and a sufficient effect can be exerted. R⁵ in Formula (B) above is not particularly limited as long as the effect is attained in the present embodiment. Examples of R⁵ include a methyl group or an ethyl group. It is difficult to perform the surface modification of the alumina particles when R⁵ is sterically large, and thus a methyl group is more preferable from the viewpoint of ease of surface modification. Incidentally, it is not preferable that R⁵ denotes a hydrogen atom since Formula (B) above is a compound having a hydroxy group in this case and thus the chemical affinity for water increases, and as a result, the charge retention ability in a high temperature and high humidity environment is diminished.

In a case in which silazane is used as the surface modifier, a compound (Formula (C)) having the following structure is generated through a deamination reaction with the hydroxy group on the surface of the alumina particles.

[Chem. 2]

(Al* —O)₁—Si (—R¹, R², R³) Formula (C)

### [Al*: Atom on Surface of Alumina Particle]

In Formula (C), R¹ to R³ are the same as those in Formula (A) above and each independently denote a hydrogen atom, an alkyl group which may have a substituent, an aryl group which may have a substituent, or an alkoxy group which may have a substituent. R¹ to R³ may be the same as or different from one another. Al* denotes an atom on the surface of the alumina particles.

In the case of using alkoxysilane (silane coupling agent) as the surface modifier, a compound (Formula (D)) having the following structure is generated through hydrolysis and dehydration reaction.

[Chem. 3]

(Al* —O)ₙ—Si (R¹) (OR²)₃₋ₙ Formula (D)

In Formula (D), R¹s are the same as those in Formula (A) above and each independently denote a hydrogen atom, an alkyl group which may have a substituent, an aryl group which may have a substituent, or an alkoxy group which may have a substituent. Res each independently denote a hydrogen atom, an alkyl group which may have a substituent, or an aryl group which may have a substituent. R¹ and R² may be the same as or different from one another. n denotes an integer 1 to 3.

As a method for modifying the surface of the alumina particles, a known method can be employed. Examples of the method for modifying the surface include a dry method and a wet method.

In the dry method, the alumina particles and the surface modifier are stirred or mixed in a fluidized bed reactor. In the wet method, alumina particles are first dispersed in a solvent to form a slurry of alumina particles. Next, a surface modifier is added to this slurry to modify (hydrophobize) the surface of the alumina particles. At this time, the alumina particles and the surface modifier are preferably heated at 100° C. to 200° C. for 0.5 to 5 hours. The hydroxy group on the alumina surface can be effectively modified by such a heat treatment. In addition, the amount of the surface modifier in the dry method and the wet method is not particularly limited but is preferably 5 to 30 parts by mass and more preferably 8 to 20 parts by mass with respect to 100 parts by mass of the alumina particles.

The content of the alumina particles is preferably 0.05 to 10 parts by mass and more preferably 0.1 to 5 parts by mass with respect to 100 parts by mass of the toner base particles. It is preferable that the content of the alumina particles is 0.05 parts by mass or more with respect to 100 parts by mass of the toner from the viewpoint of securing the fluidity and chargeability of the toner. It is preferable that the content of the alumina particles is 10 parts by mass or less with respect to 100 parts by mass of the toner from the viewpoint of suppressing the contamination of the carrier with the external additive.

(Other External Additives)

The toner of the present invention may further contain other known external additives in addition to the above-described alumina particles as an external additive or may contain external additive particles such as known inorganic particles and organic particles, lubricants, and the like. As these external additives, various ones may be used in combination. Examples of other external additives include inorganic particles such as inorganic oxide particles such as silica particles, titania particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles and inorganic stearate compound particles such as aluminum stearate particles and zinc stearate particles, or inorganic titanate compound particles such as strontium titanate and zinc titanate.

The inorganic particles may be subjected to a surface treatment such as a gloss treatment or a hydrophobization treatment with a surface treatment agent such as a silane coupling agent, a titanium coupling agent, an aluminate-based coupling agent, a higher fatty acid, a fatty acid metal salt, an esterified product thereof, rosin acid, or silicone oil in order to improve the heat resistant storage stability, to improve the environmental stability, and the like. This is also because moisture is hardly adsorbed as the inorganic particles themselves are subjected to a surface treatment and a decrease in the charge amount can be more effectively suppressed.

As the inorganic particles, (spherical) inorganic particles having a number average primary particle diameter of about 5 to 300 nm can be used.

Furthermore, organic particles can also be used as other external additives. As the organic particles, spherical organic particles having a number average primary particle diameter of about 10 to 2000 nm can be used. Specifically, organic particles of homopolymers of styrene, methyl methacrylate and the like and copolymers of these can be used.

A lubricant can also be used as an external additive. A lubricant is used for the purpose of further improving the cleaning property and the transfer property, and specific examples thereof include metal salts of higher fatty acids such as zinc, aluminum, copper, magnesium, calcium and the like salts of stearic acid, zinc, manganese, iron, copper, magnesium and the like salts of oleic acid, zinc, copper, magnesium, calcium and the like salts of palmitic acid, zinc, calcium and the like salts of linoleic acid, and zinc, calcium and the like salts of ricinoleic acid.

Incidentally, the amount of other external additives added in the toner is not particularly limited but is preferably 0.1% to 10.0% by mass and more preferably 1.0% to 3.0% by mass with respect to 100% by mass of the entire mass of the toner.

Examples of the method for adding (externally adding) the external additives include a method in which the external additives are added using various known mixing apparatuses such as a Turbuler mixer, a Henschel mixer (registered trademark), a Nauter mixer, and a V-type mixer.

<<Method for Producing Toner>>

The method for producing the toner according to the present invention is not particularly limited and examples thereof include known methods such as a kneading pulverization method, a suspension polymerization method, an emulsion aggregation method, an emulsion polymerization aggregation method (emulsion polymerization association method), a dissolution suspension method, a polyester extension method, and a dispersion polymerization method. Among these, from the viewpoint of a decrease in the particle diameter of the toner and the controllability of circularity, a build-up type production method such as an emulsion polymerization association method, a suspension polymerization method and the like are preferable to a pulverization method, and among these, an emulsion polymerization aggregation method, an emulsion aggregation method and the like can be more suitably employed.

The emulsion polymerization aggregation method to be used as the method for producing the toner according to the present invention is a method for producing toner particles by mixing a dispersion of particles of binder resin (hereinafter, also referred to as “binder resin particles”) produced by an emulsion polymerization method with a dispersion of particles of a colorant (hereinafter, also referred to as “colorant particles”) and a dispersion of a release agent such as wax, performing aggregation until the toner particles have a desired particle diameter, and further performing fusing between the binder resin particles to control the shape.

In addition, the emulsion aggregation method to be used as the method for producing the toner according to the present invention is a method for producing toner particles by dropping a binder resin solution dissolved in a solvent into a poor solvent to obtain a resin particle dispersion, mixing this resin particle dispersion with a colorant dispersion and a release agent dispersion such as wax, performing aggregation until a desired toner particle diameter is attained, and further performing fusing between the binder resin particles to control the shape.

An example of the steps in the case of using the emulsion polymerization aggregation method is presented below as a method for producing the toner of the present invention.

(1) A step of preparing a dispersion in which particles of a colorant are dispersed in an aqueous medium.

(2) A step of preparing a dispersion in which binder resin particles containing an internal additive (release agent, charge control agent and the like) if necessary are dispersed in an aqueous medium.

(3) A step of preparing a dispersion of binder resin particles by emulsion polymerization

(4) A step of mixing the dispersion of colorant particles and the dispersion of binder resin particles dispersion together to aggregate, associate, and fuse the colorant particles with the binder resin particles and thus forming toner base particles.

(5) A step of filtering the toner base particles from the dispersion system (aqueous medium) of the toner base particles to remove the surfactant and the like

(6) A step of drying the toner base particles

(7) A step of adding an external additive to the toner base particles.

In the case of producing the toner by the emulsion polymerization aggregation method, the binder resin particles obtained by the emulsion polymerization method may have a multilayer structure composed of two or more layers formed of binder resins having different compositions. For example, the binder resin particles having a two-layer structure can be obtained by a technique in which a dispersion of resin particles is prepared by an emulsion polymerization treatment (first stage polymerization) according to a conventional method, a polymerization initiator and a polymerizable monomer are added to this dispersion, and this system is subjected to a polymerization treatment (second stage polymerization).

In addition, toner particles having a core-shell structure can be obtained by an emulsion polymerization aggregation method. Specifically, core particles are first fabricated by aggregating, associating, and fusing binder resin particles for core particles with colorant particles. Subsequently, binder resin particles for shell layer are added to the dispersion of core particles, and a shell layer for covering the core particle surface is formed by aggregating and fusing the binder resin particles for shell layer on the core particle surface, whereby toner particles having a core-shell structure can be obtained.

In addition, the toner of the present embodiment may also be produced by a pulverization method. An example of the steps in the pulverization method is presented below.

(1) A step of mixing a binder resin, a colorant, and if necessary, an internal additive together using a Henschel mixer (registered trademark) and the like

(2) A step of kneading the mixture obtained using an extrusion kneader and the like while performing heating

(3) A step of roughly pulverizing the kneaded product obtained using a hammer mill and the like and then further pulverizing using a turbo mill pulverizer and the like

(4) A step of subjecting the pulverized product obtained to a fine powder classification treatment using, for example, an air sifter utilizing the Coanda effect and thus forming toner base particles

(5) A step of adding an external additive to the toner base particles.

(Method for Producing Toner in Aqueous Medium)

As a method for producing the toner of the present embodiment, the following production method in an aqueous medium is preferable. In such a production method, it is preferable to contain a binder resin precursor as the binder resin component.

For example, a compound which extends or crosslinks a binder resin precursor is dissolved in an oil phase obtained by dissolving and dispersing at least a colorant, a release agent, a crystalline polyester resin, the binder resin precursor composed of a modified polyester-based resin, and binder resin components other than these in an organic solvent. Thereafter, the oil phase is dispersed in an aqueous medium in which a (fine particle) dispersant is present to obtain an oil-in-water (O/W) type (emulsion) dispersion, the binder resin precursor is subjected to a crosslinking reaction and/or an extension reaction in the emulsified dispersion, and the organic solvent is removed, whereby toner is obtained.

As the aqueous medium to be used in the present invention, water may be used singly or water may be concurrently used with a solvent miscible with water.

Examples of the solvent miscible with water include alcohols (methanol, isopropanol, ethylene glycol and the like), dimethylformamide, tetrahydrofuran, cellsolve (registered trademark) (methyl cellosolve and the like), lower ketones (acetone, methyl ethyl ketone and the like), and the like.

A toner composition containing a binder resin precursor, a colorant, a release agent, a crystalline polyester resin (particle dispersion), a charge control agent, an unmodified polyester resin and the like, which are raw materials for forming toner base particles, may be formed by mixing these when forming a dispersed body in an aqueous medium. However, it is more preferable to produce the toner composition by mixing these toner raw materials in advance and then adding and dispersing the mixture in an aqueous medium.

In addition, other toner raw materials such as a colorant, a release agent, and a charge control agent are not required to be necessarily mixed when forming particles in an aqueous medium but may be added after the particles are formed. For example, it is also possible to add the colorant by a known dyeing method after particles not containing the colorant are formed.

The dispersion method is not particularly limited, and a method using a known disperser such as a low-speed shear type disperser, a high-speed shear type disperser, a friction type disperser, a high-pressure jet type disperser, or an ultrasonic type disperser can be applied. A high-speed shear type disperser is preferable in order to set the particle diameter of the dispersed body to 2 to 20 μm.

In the case of using a high-speed shear type disperser, the number of revolutions is not particularly limited but is usually 1000 to 30000 rpm and preferably 5000 to 20000 rpm. The dispersion time is not particularly limited but is usually 0.1 to 60 minutes in the case of a batch method. The temperature at the time of dispersion is usually 0° C. to 80° C. (under pressure) and preferably 10° C. to 40° C.

The amount of the aqueous medium used with respect to 100 parts by mass of the toner composition is usually 100 to 1000 parts by mass. It is excellent that the amount of the aqueous medium used is 100 parts by mass or more from the viewpoint of having a favorable dispersed state of the toner composition and obtaining toner base particles having a predetermined particle diameter. It is economically excellent as well when the amount is 1000 parts by mass or less.

Moreover, a dispersant can also be used if necessary. It is preferable to use a dispersant from the viewpoint that the dispersed state of the toner composition is stable as well as the particle size distribution is sharp.

The following method can be used to obtain the modified polyester resin (urea-modified polyester resin) to be contained in the binder resin precursor. In other words, examples of a method for reacting a polyester prepolymer (having an isocyanate group) with a compound having an active hydrogen group include a method in which a compound having an active hydrogen group is added and reacted before the toner composition is dispersed in an aqueous medium and a method in which a compound having an active hydrogen group is added after the toner composition is dispersed in an aqueous medium and reacted on the particle interface. In this case, a polyester modified with a polyester prepolymer is preferentially generated on the surface of the toner base particles to be produced and a concentration gradient can also be provided inside the particles. When the prepolymer is extended (or crosslinked) by the reaction with a compound having an active hydrogen group to fabricate toner base particles in this manner, the toner base particles almost do not have an interface which emulsion aggregation type toner base particles have, are particles to be hardly crushed, and are advantageous with respect to spent.

Examples of the dispersant for emulsifying and dispersing the oil phase in which the toner composition is dispersed in a liquid containing water include anionic surfactants such as alkylbenzene sulfonate salts, a-olefin sulfonate salts, and phosphoric acid esters; amine salt type cationic surfactants such as alkylamine salts, amino alcohol fatty acid derivatives, polyamine fatty acid derivatives, and imidazoline and quaternary ammonium salt type cationic surfactants such as alkyltrimethylammonium salt, dialkyldimethylammonium salt, alkyldimethylbenzylammonium salt, pyridinium salt, alkylisoquinolinium salt, and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine, and N-alkyl-N,N-dimethylammonium betaine.

In addition, the effect can be attained by using a surfactant having a fluoroalkyl group in a significantly small amount.

Examples of the anionic surfactant which has a fluoroalkyl group and is preferably used include fluoroalkylcarboxylic acids having 2 to 10 carbon atoms and metal salts thereof, disodium perfluorooctanesulfonyl glutamate, sodium 3-[omega-fluoroalkyl(C6-C11)oxy]-1-alkyl(C3-C4)sulfonate, sodium 3-[omega-fluoroalkanoyl(C6-C8)-N-ethylamino]-1-propanesulfonate, fluoroalkyl(C11-C20)carboxylic acid and metal salts thereof, perfluoroalkylcarboxylic acid (C7 to C13) and metal salts thereof, perfluoroalkyl(C4 to C12)sulfonic acid and metal salts thereof, perfluorooctanesulfonic acid diethanolamide, N-propyl-N-(2-hydroxyethyl)perfluorooctanesulfonamide, perfluoroalkyl(C6-C10)sulfonamidopropyltrimethylammonium salt, perfluoroalkyl(C6-C10)-N-ethylsulfonylglycine salt, monoperfluoroalkyl(C6-C16)ethylphosphoric acid ester, and the like.

Examples of product names thereof include SURFLON (registered trademark) S-111, S-112, and S-113 (manufactured by AGC SEMI CHEMICAL CO., LTD.), FLORARD FC-93, FC-95, FC-98, and FC-129 (manufactured by 3M Japan Limited), UNIDYNE DS-101 and DS-102, (manufactured by DAIKIN INDUSTRIES, Ltd.), MEGAFACE (registered trademark) F-110, F-120, F-113, F-191, F-812, and F-833 (manufactured by DIC Corporation), EFTOP EF-102, 103, 104, 105, 112, 123A, 123B, 306A, 501, 201, and 204 (manufactured by Mitsubishi Materials Electronic Chemicals Co., Ltd.), FTERGENT (registered trademark) F-100 and F150 (manufactured by NEOS COMPANY LIMITED), and the like.

Examples of the cationic surfactants include aliphatic primary, secondary, or tertiary amine acids having a fluoroalkyl group, aliphatic quaternary ammonium salts such as perfluoroalkyl(C6-C10)sulfonamidopropyltrimethylammonium salt, benzalkonium salt, benzethonium chloride, pyridinium salt, and imidazolinium salt, and examples of product names thereof include SURFLON (registered trademark) S-121 (manufactured by AGC SEMI CHEMICAL CO., LTD.), FLORARD FC-135 (manufactured by 3M Japan Limited), UNIDYNE DS-202 (manufactured by DAIKIN INDUSTRIES, Ltd.), MEGAFACE (registered trademark) F-150 and F -824 (manufactured by DIC Corporation), EFTOP EF-132 (manufactured by Mitsubishi Materials Electronic Chemicals Co., Ltd.), FTERGENT (registered trademark) F-300 (manufactured by NEOS COMPANY LIMITED), and the like.

In addition, as the inorganic compound dispersant to be hardly soluble in water, tricalcium phosphate, calcium carbonate, titanium oxide, colloidal silica, hydroxyapatite and the like can be used.

In addition, the dispersed droplets may be stabilized with polymer-based protective colloids or organic fine particles insoluble in water.

Examples of the polymer-based protective colloids or organic fine particles insoluble in water include resin particles such as styrene-(meth)acrylic resin the same as those described above. In addition, sodium salt of ethylene oxide adduct sulfuric acid ester may be used as an acid monomer in order to impart stability.

Incidentally, in the case of using one that is soluble in acids and alkalis such as calcium phosphate as a dispersion stabilizer, the calcium phosphate is removed from the fine particles by a method in which the calcium phosphate is dissolved in an acid such as hydrochloric acid and then washed with water, and the like. The calcium phosphate can be removed by other operations such as enzymatic degradation as well.

In the case of using a dispersant, the dispersant can remain on the surface of the toner base particles but it is preferable to remove the dispersant by washing after the reaction from the viewpoint of charging of the toner.

Furthermore, in order to lower the viscosity of the toner composition, it is possible to use a solvent with which the polyester prepolymer reacts and in which modified polyester is soluble. It is preferable to use a solvent from the viewpoint that the particle size distribution is sharp.

It is preferable that the solvent has a boiling point of less than 100° C. to be volatile from the viewpoint of being easily removed.

As the solvent, for example, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone and the like can be used singly or in combination of two or more kinds thereof. In particular, aromatic solvents having a boiling point of less than 100° C. and halogenated hydrocarbons such as methylene chloride, 1,2-dichloroethane, chloroform, and carbon tetrachloride are preferable.

The amount of the solvent used with respect to 100 parts by mass of the polyester prepolymer is usually 0 to 300 parts by mass, preferably 0 to 100 parts by mass, and still more preferably 25 to 70 parts by mass. In the case of using a solvent, the solvent is removed by heating at normal pressure or under reduced pressure after the extension and/or crosslinking reaction.

The extension and/or crosslinking reaction time is selected depending on the reactivity by the combination of the polyester prepolymer with a compound having an active hydrogen group but is usually 10 minutes to 40 hours and preferably 30 minutes to 24 hours. The reaction temperature is usually 0° C. to 100° C. and preferably 10° C. to 50° C. Moreover, a known catalyst can also be used if necessary.

Specific examples of the compound having an active hydrogen group include tertiary amines such as triethylamine, imidazole and the like.

In order to remove the organic solvent from the emulsified and dispersed body obtained, it is possible to employ a method in which the temperature of the entire system is gradually raised to completely evaporate and remove the organic solvent in the droplets. It is also possible to spray the emulsified and dispersed body in a dry atmosphere to completely remove the water-insoluble organic solvent in the droplets, to form toner fine particles, and to evaporate and remove the aqueous dispersant as well.

As the dry atmosphere into which the emulsified and dispersed body is sprayed, gases obtained by heating air, nitrogen, carbon dioxide gas, combustion gas and the like, particularly various air streams heated to a temperature equal to or more than the boiling point of the solvent having the highest boiling point are generally used. The intended quality is attained by a treatment for a short time when apparatuses such as a spray dryer, a belt dryer, and a rotary kiln are used.

In a case in which the particle size distribution at the time of emulsification and dispersion is wide and washing and drying treatments are performed while maintaining the particle size distribution, the particle size distribution can be adjusted by classification into a desired particle size distribution.

Classification can be performed by removing fine particle portions in a liquid by a cyclone, a decanter, centrifugation, and the like. Of course, the classification operation may be performed after acquiring the particles as a powder after drying, but it is preferable to perform the classification operation in a liquid from the viewpoint of efficiency. The unnecessary fine particles or coarse particles obtained can be returned to the kneading step again and used in the formation of particles. At that time, the fine particles or coarse particles may be in a wet state.

It is preferable to remove the dispersant used from the dispersion obtained as much as possible, but it is preferable to simultaneously perform the removal of the dispersant with the classification described above.

The toner powder obtained after drying is mixed with different particles such as release agent particles, charge controlling particles, fluidizer particles, and colorant particles or the mixed powder is compounded by applying a mechanical impulsive force thereto and thus the detachment of the different particles from the surface of the compounded particles to be obtained can be prevented.

As a specific mixing method, there are a method in which an impulsive force is applied to the mixture using blades rotating at a high speed, a method in which the mixture is injected into a high-speed air stream, the speed is accelerated, and the particles or compounded particles are allowed to collide with an appropriate collision plate, and the like.

Examples of the mixing apparatus include an angmill (manufactured by HOSOKAWA MICRON CORPORATION), a I-type mill (manufactured by NIPPON PNEUMATIC MFG CO., LTD.) modified so as to have a lowered pulverization air pressure, a hybridization system (manufactured by NARA MACHINERY CO., LTD.), a KRYPTRON SYSTEM (manufactured by Kawasaki Heavy Industries, Ltd.), an automatic mortar and the like.

[Particle Diameter of Toner Particles]

The particle diameter of the toner particles constituting the toner of the present embodiment is preferably 3 to 8 μm and more preferably 3 to 6 μm, for example, as a volume-based median diameter. It is excellent that the particle diameter of the toner particles is 3 μm or more from the viewpoint that sufficient fluidity can be maintained. In addition, it is excellent that the particle diameter of the toner particles is 8 μm or less from the viewpoint that high image quality can be maintained.

As the volume-based median diameter is in the above range, the transfer efficiency increases, the image quality of halftone is improved, and the image quality of fine lines, dots, and the like is improved.

The volume-based median diameter of the toner particles is measured and calculated using a measuring apparatus in which a computer system for data processing (manufactured by Beckman Coulter, Inc.) is connected to “Multisizer 3” (manufactured by Beckman Coulter, Inc.).

Specifically, 0.02 g of toner is added to and mixed with 20 mL of a surfactant solution (for example, a surfactant solution prepared by diluting a neutral detergent containing a surfactant component with pure water 10 times for the purpose of dispersing the toner particles). Thereafter, a ultrasonic dispersion treatment is performed for 1 minute to prepare a dispersion of toner particles, this dispersion of toner particles is injected into a beaker containing “ISOTON II” (manufactured by Beckman Coulter, Inc.) in a sample stand using a tubette until the display density by the measuring apparatus reaches 5% to 10%. Here, a reproducible measurement value can be attained by setting the concentration to this concentration range. Thereafter, the number of counts of the measurement particles is set to 25000 and the aperture diameter is set to 50 μm in the measuring apparatus, the frequency values are calculated by dividing the measurement range of 1 to 30 μm into 256, and the particle diameter at 50% from the larger cumulative volume fraction is taken as the volume-based median diameter.

<Carrier>

The carrier is composed of a magnetic material. The carrier constituting the two-component developer of the present embodiment is carrier particles (also referred to as a covered carrier) having a core material composed of a magnetic material and a resin layer covering the surface of the core material from the viewpoint of suppressing attachment of the carrier to the photoreceptor. Furthermore, in the present embodiment, the resin layer contains a silicone resin.

<Core Material>

The core material is not particularly limited, and carriers known as a carrier constituting a two-component developer, for example, ferrite (also referred to as fired ferrite), Cu—Zn ferrite, Mn ferrite, Mn—Mg ferrite, Mn—Mg—Sr ferrite, magnetite, iron, nickel and the like may be appropriately selected and used according to the applications and the purpose of use of the carrier.

(Particle Diameter and Magnetization of Core Material)

The average particle diameter of the core material is preferably 10 to 100 μm and more preferably 20 to 80 μm. The average particle diameter measurement of the core material can be performed in the same manner as the measurement method of the weight average particle diameter of the carrier to be described below (for details, see the measurement method described in Examples). Furthermore, the magnetization characteristic of the magnetic material itself is preferably 2.5×10⁻⁵ to 15.0×10⁻⁵ Wb·m/kgG as a saturation magnetization. The saturation magnetization is measured using “direct current magnetization characteristic automatic recorder 3257-35” (manufactured by Yokogawa Electric Corporation).

(Method for Fabricating Core Material)

The core material is fabricated through a process of granulating and drying the raw materials (for example, metal oxides, metal hydroxides and the like in the case of raw materials of ferrite) of the core material, then performing firing by a heat treatment, and crushing and classifying the core material obtained. The firing step is performed by placing the particles granulated and dried in a vessel and placing the vessel in a firing furnace.

<Resin Layer>

In the present embodiment, the resin layer of the carrier essentially contains a silicone resin. As the binder resin of the toner contains a crystalline polyester resin, it is disadvantageous from the viewpoint of spent on the carrier when the developer is endured since the toner is soft even at a temperature close to normal temperature while it is advantageous from the viewpoint of low-temperature fixing. However, in the two-component developer of the present embodiment, even when a crystalline polyester resin is contained in the binder resin of the toner, it is excellent to use a silicone resin having a low surface energy in the resin layer of the carrier from the viewpoint that the toner hardly spends on the carrier while maintaining the low-temperature fixability.

(Silicone Resin)

The silicone resin in the present invention refers to all commonly known silicone resins, and specific examples thereof include straight silicone consisting only of organosiloxane bonds, silicone resins modified with alkyd, polyester, epoxy, acryl, urethane and the like, and the like but are not limited thereto. Examples of straight silicone resins as commercially available products include KR271, KR255, and KR152 manufactured by Shin-Etsu Chemical Co., Ltd., SR2400, SR2406, and SR2410 manufactured by Dow Corning Toray Co., Ltd., and the like. In this case, it is possible to use the silicone resin simple substance, but it is also possible to simultaneously use other components which undergo a crosslinking reaction, charge amount adjusting components, and the like. Furthermore, examples of modified silicone resins as commercially available products include KR206 (alkyd-modified), KR5208 (acrylic-modified), ES1001N (epoxy-modified), and KR305 (urethane-modified) manufactured by Shin-Etsu Chemical Co., Ltd., SR2115 (epoxy-modified) and SR2110 (alkyd-modified) manufactured by Dow Corning Toray Co., Ltd., and the like.

The resin layer of the carrier may contain another resin and the like in addition to the silicone resin. An acrylic resin is preferable as another resin. An acrylic resin exhibits strong adhesive property and low brittleness thus exhibits significantly excellent properties in wear resistance, and deterioration such as scraping and peeling off of the resin layer hardly occurs, thus the resin layer can be stably maintained. In addition to these, by strong adhesive property of acrylic resin, particles which can be contained in the resin layer, such as particles containing alumina and conductive fine particles can be firmly held. Furthermore, an acrylic resin is preferable since it can compensate for the drawbacks of the silicone resin.

The acrylic resin in the present invention refers to all resins having an acrylic component and is not particularly limited. In addition, it is possible to use the acrylic resin simple substance, but it is also possible to simultaneously use at least one or more other components which undergo a crosslinking reaction. Examples of other components which undergo a crosslinking reaction mentioned here include amino resins, acidic catalysts and the like but are not limited thereto. The amino resin mentioned here refers to guanamine, melamine resins and the like but is not limited thereto. In addition, the acidic catalyst mentioned here is, for example, an acidic catalyst having a reactive group such as a fully alkylated type, a methylol group type, an imino group type, or a methylol/imino group type but is not limited thereto.

(Particles Containing Alumina)

The resin layer of the carrier preferably contains particles containing alumina having a number average primary particle diameter of 100 nm or more and 500 nm or less.

As particles containing alumina having a number average primary particle diameter of 100 nm or more and 500 nm or less are contained in the resin layer of the carrier, it is possible to impart irregularities to the carrier surface layer and to decrease the contact area with the toner and thus the spent is further suppressed. It is excellent that the number average primary particle diameter of the particles is 100 nm or more from the viewpoint that the spent suppressing effect is great. In addition, when the number average primary particle diameter of the particles is 500 nm or less, fixing is hardly inhibited when the particles are transferred from the carrier to the toner. It is preferable that the particles having a number average primary particle diameter of 100 nm or more and 500 nm or less are particles containing alumina as an external additive from the viewpoint of inhibiting fixing. As particles containing alumina are contained in the resin layer of the carrier, irregularities are formed on the surface of the resin layer of the carrier and the contact area with the toner can be decreased. In addition, the heat generated by the mixing of the developer is released from the carrier as alumina having a high thermal conductivity is present, and the influence of the heat on the toner is suppressed, thus the spent resistance is improved. The number average primary particle diameter of the particles containing alumina in the resin layer of the carrier is more preferably 200 nm or more and 400 nm or less from the viewpoint of excellent low-temperature fixability, high spent suppressing effect, and higher fogging suppressing effect. Incidentally, as the method for measuring the number average primary particle diameter of the particles containing alumina in the resin layer of the carrier, a method for measuring the number average primary particle diameter of the alumina particles of an external additive is applicable.

Furthermore, it is preferable that the particles containing alumina have a core-shell structure, alumina is contained in the core portion, and at least either of indium or tin is contained in the shell portion. As a shell portion containing at least either of indium or tin is provided in this manner, the resistance of the particles can be decreased, charging can be suppressed, the amount transferred to the toner can be decreased, and the inhibition of fixing can be suppressed.

It is only required that alumina is contained in the core portion, but it is preferable that particles having an alumina content of preferably 50% or more, more preferably 80% or more, and still more preferably 90% or more are used in the core portion. Particles (alumina particles) composed only (100%) of alumina single substance are particularly preferable. Examples of components to be contained in the core portion other than alumina include silica, titania, and the like. In addition, the shape of the core portion is not particularly limited, and examples thereof include a spherical shape, an elliptical cross-sectional shape, a disc shape, a cylindrical shape, a prismatic shape, a rod shape, a needle shape, an indefinite shape and the like. A spherical shape is preferable from the viewpoint of dispersibility.

It is preferable that at least either of indium or tin is contained in the shell portion. Among these, as a form containing both indium and tin, for example, it is preferable that the vicinity of the core portion is covered with any of metals, alloys, or oxides of indium and tin as the shell portion. Among these, it is more preferable that the vicinity of the core portion is covered with oxides of these metals since the resistance hardly decreases. As the vicinity of the core portion is covered with oxides of indium and tin in this manner, the particles can have a lower resistance and charging can be suppressed. By this, the amount transferred to the toner is further decreased and inhibition of fixing can be further suppressed.

(Confirmation of Core-Shell Structure)

The core-shell structure of the particles containing alumina can be confirmed by fabricating a section and observing the section by the following method. The shell portion in the vicinity of the core portion may be layered or may be disposed as particles in the vicinity of the core portion.
Sample: section (thickness of section: 100 to 150 nm) obtained from carrier surface using focused ion beam processing apparatus (FIB)
FIB processing conditions: used Ga ion at acceleration voltage of 30 kV
TEM observation apparatus: transmission electron microscope (TEM) “JEM-2010F” (manufactured by JEOL Ltd.)
TEM observation conditions: observed bright field image at acceleration voltage of 200 kV.

It can be analyzed that at least either of indium or tin is contained in the shell portion of the particles having a core-shell structure by combining TEM observation by the above-mentioned thin section fabrication method with EDS. In addition, it is also possible to analyze the fact that the particles have a core-shell structure, the material of the core portion, the material of the shell portion, the number average primary particle diameter of the core-shell particles, the number average primary particle diameter of the core portion, the average film thickness of the shell portion, and the like by these analysis methods.

As a method for forming the shell portion in the vicinity of the core portion, for example, a method in which the surface of the core portion (alumina particles) is covered with indium oxide hydrate containing a hydrate of tin dioxide and this is subjected to a heat treatment at 350° C. to 750° C. in an inert gas atmosphere is preferable but it is not necessarily limited thereto.

Examples of more detailed production methods include aspects as to be described below.

First, a coating film of a hydrate of indium oxide containing tin dioxide is formed on the surface of the core portion (alumina particles). There are various methods as this method, but for example, a method in which a mixed solution of a tin salt and an indium salt and an alkali are separately added to an aqueous suspension of alumina in parallel to form a coating film is more preferable. At this time, it is more preferable to heat the aqueous suspension to 50° C. to 100° C. In addition, it is important that the pH when the mixed solution and the alkali are added in parallel is preferably 2 to 9 and more preferably 2 to 5 or is maintained at 6 to 9. By this, the hydrolysis reaction product of tin and indium can be uniformly deposited.

As a raw material of tin, for example, tin chloride, tin sulfate, tin nitrate and the like can be used. As a raw material of indium, for example, indium chloride, indium sulfate and the like can be used.

The amount of tin dioxide (SnO₂) is 0.1 to 20 parts by mass and preferably 2.5 to 15 parts by mass as tin dioxide (SnO₂) with respect to 100 parts by mass of indium oxide (In₂O₃) in the case of concurrently using indium oxide. It is excellent that the amount of tin dioxide (SnO₂) is in the above range from the viewpoint of attaining the desired conductivity.

The amount of tin dioxide (SnO₂) is 1 to 200 parts by mass and preferably 5 to 100 parts by mass as tin dioxide (SnO₂) with respect to 100 parts by mass of the core portion. It is excellent that the amount of tin dioxide (SnO₂) is in the above range from the viewpoint of attaining the desired conductivity.

The amount of indium oxide (In₂O₃) is 5 to 200 parts by mass and preferably 8 to 150 parts by mass as indium oxide (In₂O₃) with respect to 100 parts by mass of the core portion. The desired conductivity is attained when the amount of indium oxide (In₂O₃) is in the above range, and the conductivity is more improved as the amount of indium oxide (In₂O₃) increases when the amount of indium oxide (In₂O₃) is in the above range. Meanwhile, it is more advantageous from the viewpoint of cost as the content of expensive indium oxide (In₂O₃) is decreased when the amount of indium oxide (In₂O₃) is in the above range.

The proportion of the resin layer with respect to 100 parts by mass of the core material is preferably 1 part by mass or more and 5 parts by mass or less and more preferably 1.5 parts by mass or more and 4 parts by mass or less. The charged amount can be effectively maintained when the proportion of the resin layer is 1 part by mass or more. Moreover, the resistance can be prevented from increasing too high when the proportion of the resin layer is 5 parts by mass or less.

(Method for Fabricating Resin Layer)

Examples of specific methods for fabricating the resin layer of the carrier include a wet coating method and a dry coating method. The respective methods are described below.

(Wet Coating Method)

As the wet coating method, there are the following ones.

(1) Fluidized Bed Spray Coating Method

Examples thereof include a method in which a coating solution prepared by dissolving (dispersing) a resin for covering which is used in the formation of a resin layer and contains a silicone resin in a solvent is sprayed and applied onto the surface of the core material using a fluidized bed and then dried to fabricate a resin layer, and the like. The coating solution can contain particles containing alumina.

(2) Immersion Coating Method

Examples thereof include a method in which the core material is immersed in and coated with a coating solution prepared by dissolving (dispersing) a resin for covering which is used in the formation of a resin layer and contains a silicone resin in a solvent and then dried to fabricate a resin layer, and the like. The coating solution can contain particles containing alumina.

(3) Polymerization Method

Examples thereof include a method in which the core material is immersed in and coated with a coating solution prepared by dissolving a reactive compound which is used in the formation of a resin layer and contains a silicone resin in a solvent and then heat and the like are applied thereto for the polymerization reaction, thereby fabricating a resin layer, and the like.

(Dry Coating Method)

The dry coating method is a method in which the resin particles which are used in the formation of a resin layer and contain a silicone resin are deposited on the surface of the core material to be covered and then mechanical impulsive force is applied thereto, thus the resin particles deposited on the surface of the core material to be covered are melted or softened and fixed, thereby fabricating a resin layer.

<Carrier Properties>

(Carrier Resistance)

As the volume resistivity of the carrier is 10 Log (Ω·cm) or more and 16 Log (Ω·cm) or less, the amelioration effect of the invention is remarkable. It is preferable that the volume resistivity of the carrier is 10 Log (Ω·cm) or more from the viewpoint that the carrier attachment in the non-image area hardly occurs. Meanwhile, it is preferable that the volume resistivity of the carrier is 16 Log (Ω·cm) or less from the viewpoint that the edge effect can be improved to a sufficiently acceptable level. Incidentally, in a case in which the volume resistivity falls below the measurable lower limit by a high resist meter, the volume resistivity value is not substantially attained and is regarded as a breakdown.

A method for measuring the volume resistivity in the present invention will be described below.

As illustrated in FIG. 2, a carrier 23 is filled in a cell 21 which accommodates an electrode 22a and an electrode 22b having a distance between electrodes of 2 mm and a surface area of 2×4 cm and is composed of a fluororesin vessel, and tapping operation is performed for 1 minute at a tapping speed of 30 times/min using a tapping machine PTM-1 type manufactured by SANKYO PIO-TECH CO., LTD.. A direct current voltage of 1000V is applied to between both poles, the direct current resistance is measured using a high resistance meter 4329A (4329A+LJK 5HVLVWDQFH 0HWHU; manufactured by Hewlett-Packard Japan, Ltd.), the electrical resistivity RΩ·cm is determined, and LogR is calculated.

(Particle Diameter of Carrier)

As the weight average particle diameter of the carrier is 20 μm or more and 65 μm or less, the amelioration effect of the invention is remarkable. It is preferable that the weight average particle diameter is 20 μm or more since the uniformity of the particles is likely to be improved, thus the technology which can be sufficiently used on the machine (image forming apparatuses such as a printing machine and a copying machine) side is established, and problems such as carrier attachment hardly occur. Meanwhile, it is preferable that the weight average particle diameter is 65 μm or less since the reproducibility of image details is favorable and a fine image can be attained.

The weight average particle diameter of the carrier in the present invention can be measured using SRA type of Microtrac Particle Size Analyzer (manufactured by Nikkiso Co., Ltd.). Measurement was performed in a range set to 0.7 μm or more and 125 μm or less. In addition, methanol is used as a dispersing liquid, and the refractive index is set to 1.33, and the refractive indexes of the carrier and the core material are set to 2.42.

<<Two-Component Developer>>

The two-component developer according to the present invention can be fabricated by appropriately mixing toner and a carrier so that the toner concentration (content) is preferably 1% to 10% by mass and more preferably 4% to 8% by mass. It is preferable that the toner concentration in the two-component developer is 1% by mass or more since it can be suppressed that the charged amount increases too high and the developability is improved. Meanwhile, it is preferable that the toner concentration in the two-component developer is 10% by mass or less since it can be suppressed that the charged amount decreases too low and it can be effectively prevented that toner scattering occurs.

Examples of the mixing apparatus to be used for the mixing include Henschel mixer (registered trademark), Nauter mixer (registered trademark), W cone and V-type mixer.

Incidentally, embodiments to which the present invention can be applied are not limited to the above-described embodiments, and can be appropriately changed without departing from the spirit of the present invention.

### EXAMPLES

Hereinafter, embodiments of the present invention will be specifically described with reference to Examples, but the present invention is not limited thereto. In the following Examples, unless otherwise stated, “parts” and “%” mean “parts by mass” and “mass%”, respectively, and the respective operations were performed at room temperature (25° C.).

<Synthesis of Crystalline Polyester Resin>

(Synthesis of Crystalline Polyester Resin 1)

In a 5 liter four-necked flask equipped with a nitrogen inlet tube, a dehydration tube, a stirrer, and a thermocouple (temperature sensor), 2,300 g of 1,10-decanedioic acid having an acid chain length (C_{acid}) of 10 as a polycarboxylic acid, 2,530 g of 1,6-hexanediol having an alcohol chain length (C_{alcohol}) of 6 as a polyhydric alcohol, 4.9 g of hydroquinone were put and reacted at 180° C. for 10 hours. Thereafter, the temperature was raised to 200° C., the reaction was allowed to proceed for 3 hours, and further the reaction was allowed to proceed at 8.3 kPa for 2 hours to obtain crystalline polyester resin 1.

(Synthesis of Crystalline Polyester Resins 2 to 5)

Crystalline polyester resins 2 to 5 were obtained in the same manner as in the synthesis of crystalline polyester resin 1 except that the combination of the acid component (polycarboxylic acid) and the alcohol component (polyhydric alcohol) was changed as presented in the following Table 1.

(Synthesis of Amorphous Polyester Resin 1)

In a 5 liter four-necked flask equipped with a nitrogen inlet tube, a dehydration tube, a stirrer, and a thermocouple (temperature sensor), 229 parts of bisphenol A ethylene oxide 2 mol adduct, 529 parts of bisphenol A propylene oxide 3 mol adduct, 100 parts isophthalic acid, 108 parts terephthalic acid, 46 parts of adipic acid, and 2 parts of dibutyltin oxide were put and reacted at 230° C. and normal pressure (atmospheric pressure) for 10 hours. The reaction was further allowed to proceed at room temperature (25° C.) for 5 hours under reduced pressure of 10 to 15 mmHg (1.33 to 2.00 kPa). Thereafter, 30 parts of trimellitic anhydride was put in the reaction vessel and the reaction was allowed to proceed at 180° C. and normal pressure for 3 hours to obtain amorphous polyester resin 1.

<<Fabrication of Toner>>

(Preparation of Crystalline Polyester Resin Particle Dispersion 1)

In a metal 2L vessel, 100 g of the crystalline polyester resin 1 obtained above and 400 g of ethyl acetate were put, dissolved by being heated at 75° C., and then rapidly cooled in an ice-water bath at a rate of 27° C./min. To this, 500 ml of glass beads (3 mmφ) was added, and pulverization was performed for 10 hours using a batch type sand mill apparatus (manufactured by Kanpe Hapio Co., Ltd.) to obtain crystalline polyester resin particle dispersion 1.

(Preparation of Crystalline Polyester Resin Particle Dispersions 2 to 5)

In addition, crystalline polyester resin particle dispersion 2 was obtained in the same manner as in the preparation of crystalline polyester resin particle dispersion 1 except that the crystalline polyester resin 1 was changed to the crystalline polyester resin 2.

In addition, crystalline polyester resin particle dispersion 3 was obtained in the same manner as in the preparation of crystalline polyester resin particle dispersion 1 except that the crystalline polyester resin 1 was changed to the crystalline polyester resin 3.

In addition, crystalline polyester resin particle dispersion 4 was obtained in the same manner as in the preparation of crystalline polyester resin particle dispersion 1 except that the crystalline polyester resin 1 was changed to the crystalline polyester resin 4.

In addition, crystalline polyester resin particle dispersion 5 was obtained in the same manner as in the preparation of crystalline polyester resin particle dispersion 1 except that the crystalline polyester resin 1 was changed to the crystalline polyester resin 5.

(Fabrication of Prepolymer 1)

In a reaction vessel equipped with a cooling tube, a stirrer, and a nitrogen inlet tube, 682 parts of bisphenol A ethylene oxide 2 mol adduct, 81 parts of bisphenol A propylene oxide 2 mol adduct, 283 parts of terephthalic acid, 22 parts of trimellitic anhydride, and 2 parts of dibutyltin oxide were put and reacted at 230° C. and normal pressure (atmospheric pressure) for 8 hours. The reaction was further allowed to proceed at room temperature (25° C.) for 5 hours under reduced pressure of 10 to 15 mmHg (1.33 to 2.00 kPa) to obtain intermediate polyester 1.

The intermediate polyester 1 obtained had a number average molecular weight of 2,100, a weight average molecular weight of 9,500, a glass transition temperature (Tg) of 55° C., an acid value of 0.5, and a hydroxyl value of 51.

Next, in a reaction vessel equipped with a cooling tube, a stirrer, and a nitrogen inlet tube, 410 parts of the intermediate polyester 1, 89 parts of isophorone diisocyanate, and 500 parts of ethyl acetate were put and reacted at 100° C. for 5 hours to obtain prepolymer 1.

The free isocyanate amount in the prepolymer 1 obtained was 1.53%.

(Preparation of Ketimine Compound 1)

In a reaction vessel equipped with a stirring bar and a thermometer, 170 parts of isophoronediamine and 75 parts of methyl ethyl ketone were put and reacted at 50° C. for 5 hours to obtain ketimine compound 1. The amine value of the ketimine compound 1 obtained was 418.

(Fabrication of Master Batch (MB) 1)

Added were 1200 parts of water, 540 parts of carbon black (Printex (registered trademark) 35, manufactured by Degussa AG) (DBP oil absorption=42 m1/100 mg, pH=9.5), and 1200 parts of crystalline polyester resin 1, and these were mixed together using Henschel mixer (registered trademark) (manufactured by NIPPON COKE & ENGINEERING CO., LTD.). The mixture was kneaded at 150° C. for 30 minutes using two rolls, then rolled and cooled, and pulverized using a pulverizer to obtain a master batch (MB) 1.

(Fabrication of Pigment and Release Agent (Wax) Dispersion 1)

In a vessel equipped with a stirring bar and a thermometer, 378 parts of amorphous polyester resin 1, 110 parts of carnauba wax, 22 parts of CCA (charge control agent) (salicylic acid metal complex: BONTRON (registered trademark) E-84: manufactured by Orient Chemical Industries Co., Ltd.), and 947 parts of ethyl acetate were put, the temperature was raised to 80° C. while performing stirring, maintained at 80° C. for 5 hours, and then lowered to 30° C. over 1 hour. Subsequently, 500 parts of master batch 1 and 500 parts of ethyl acetate were put in a vessel and mixed together for 1 hour to obtain raw material solution 1.

To a vessel, 1324 parts of the raw material solution 1 obtained was transferred, and carbon black and release agent (wax) particles were dispersed therein under the conditions of a liquid feeding speed of 1 kg/hr, a disk peripheral velocity of 6 m/sec, a filling factor of 0.5 mm zirconia beads of 80% by volume, and 3 passes using a bead mill (Ultra Visco Mill manufactured by AIMEX CO., LTD.).

Subsequently, 1042.3 parts of a 65% ethyl acetate solution of amorphous polyester resin 1 was added thereto, and one pass was performed using a bead mill under the above conditions to obtain pigment and release agent (wax) particle dispersion 1. The solid concentration (130° C., 30 minutes) in the pigment and release agent (wax) dispersion 1 obtained was 50%.

(Dispersant: Fabrication of Organic Fine Particle Dispersion (Vinyl Resin Particle Dispersion 1))

In a reaction vessel equipped with a stirring bar and a thermometer, 683 parts of water, 11 parts of methacrylic acid ethylene oxide adduct sulfate sodium salt (ELEMINOL (registered trademark) RS-30: manufactured by Sanyo Chemical Industries, Ltd.), 138 parts of styrene, 138 parts of methacrylic acid, and 1 part of ammonium persulfate were put and stirred at 400 rpm for 15 minutes, as a result, a white emulsion was obtained. The system was heated to raise the temperature in the system to 75° C. and the reaction was allowed to proceed for 5 hours. Furthermore, 30 parts of a 1% aqueous solution of ammonium persulfate was added thereto, and aging was performed at 75° C. for 5 hours to obtain an aqueous dispersion (vinyl resin particle dispersion 1) of vinyl resin (copolymer of styrene-methacrylic acid-methacrylic acid ethylene oxide adduct sulfate sodium salt) particles.

The volume average particle diameter of the vinyl resin particles 1 in the vinyl resin particle dispersion 1 obtained was measured by LA-920. As a result, the volume average particle diameter of the vinyl resin particles 1 was 140 nm (0.14 μm).

(Preparation of Aqueous Phase 1)

A milky white liquid was obtained by mixing and stirring 990 parts water, 83 parts of vinyl resin particle dispersion 1 as a dispersant, 37 parts of a 48.5% aqueous solution of sodium dodecyl diphenyl ether disulfonate (ELEMINOL (registered trademark) MON-7: Sanyo Chemical Industries, Ltd.), and 90 parts of ethyl acetate. This was used as aqueous phase 1.

<Fabrication of Toner Base Particles 1>

(Emulsification and Solvent Removal Step; Fabrication of Dispersed Slurry 1)

In a vessel, 664 parts of pigment and release agent (wax) dispersion 1, 109.4 parts of prepolymer 1, 73.9 parts of crystalline polyester resin particle dispersion 1, and 4.6 parts of ketimine compound 1 were put and mixed at 5,000 rpm for 1 minute using TK homomixer (manufactured by PRIMIX Corporation). Thereafter, 1200 parts of aqueous phase 1 was added into the vessel, and mixing was performed at 13,000 rpm for 20 minutes using TK homomixer to obtain emulsified slurry 1.

The emulsified slurry 1 was put in a vessel equipped with a stirrer and a thermometer, and the solvent was removed at 30° C. for 8 hours, aging was performed at 45° C. for 4 hours to obtain a dispersed slurry 1.

(Washing and Drying Step)

After 100 parts of the dispersed slurry 1 was filtered under reduced pressure, (1): 100 parts of ion-exchanged water was added to the filter cake, mixing was performed using TK homomixer (at the number of revolutions of 12,000 rpm for 10 minutes), and the mixture was then filtered. (2): 100 parts of a 10% aqueous solution of sodium hydroxide was added to the filter cake of (1) above, mixing was performed using TK homomixer (at the number of revolutions of 12,000 rpm for 30 minutes), and the mixture was then filtered under reduced pressure. (3): 100 parts of 10% hydrochloric acid was added to the filter cake of (2) above, mixing was performed using TK homomixer (at the number of revolutions of 12,000 rpm for 10 minutes), and the mixture was then filtered. (4): the operation in which 300 parts of ion-exchanged water was added to the filter cake of (3) above, mixing was performed using TK homomixer (at the number of revolutions of 12,000 rpm for 10 minutes), and the mixture was then filtered was performed two times to obtain filter cake 1.

The filter cake 1 obtained was dried at 45° C. for 48 hours using a circulating dryer and sieved using a mesh having an opening of 75 μm to obtain toner base particles 1.

<Fabrication of Toner Base Particles 2 to 6>

In addition, toner base particles 2 were obtained in the same manner as in the fabrication of toner base particles 1 except that the crystalline polyester resin particle dispersion 1 was changed to the crystalline polyester resin particle dispersion 2.

In addition, toner base particles 3 were obtained in the same manner as in the fabrication of toner base particles 1 except that the crystalline polyester resin particle dispersion 1 was changed to the crystalline polyester resin particle dispersion 3.

In addition, toner base particles 4 were obtained in the same manner as in the fabrication of toner base particles 1 except that the crystalline polyester resin particle dispersion 1 was changed to the crystalline polyester resin particle dispersion 4.

In addition, toner base particles 5 were obtained in the same manner as in the fabrication of toner base particles 1 except that the crystalline polyester resin particle dispersion 1 was changed to the crystalline polyester resin particle dispersion 5.

In addition, the crystalline polyester resin particle dispersion 1 was eliminated, but the amount of the pigment and release agent (wax) dispersion 1 was increased by the amount of the crystalline polyester resin particle dispersion 1, whereby toner base particles 6 were obtained.

<External Additive Particles; Fabrication of Alumina Particles 1 to 6>

In an evaporator, 320 kg of aluminum trichloride (AlCl₃) was evaporated at about 200° C., and chloride vapor was allowed to pass through the mixing chamber of the burner with nitrogen. Here, the gas stream was mixed with 100 Nm³/h of hydrogen and 450 Nm³/h of air and supplied to the flame via the central tube (diameter: 7 mm). As a result, the burner temperature was 230° C., and the discharge speed from the tube was about 35.8 m/s. As jacket type gas, 0.05 Nm³/h of hydrogen was supplied via the outer tube. The gas combusted in the reaction chamber and was cooled to about 110° C. in the downstream aggregation zone. The aggregation of primary particles of alumina was performed at this place. The aluminum oxide particles obtained were separated from the hydrochloric acid-containing gas to be generated at the same time in the filter or cyclone, and the powder containing wet air was treated at about 500° C. to 700° C. to remove adhesive chlorides. Alumina particles were obtained in this manner.

The particle diameter (number average primary particle diameter) of alumina can be adjusted by the reaction conditions (for example, flame temperature and percentage content of hydrogen or oxygen), quality of aluminum trichloride, retention time in the flame, length of aggregation zone, and the like.

The alumina particles obtained were put in a reaction vessel, one prepared by diluting 18 g of surface modifier isobutyltrimethoxysilane with 60 g of hexane was added to 100 g of alumina powder while stirring the powder using a rotating blade in a nitrogen atmosphere, and the mixture was heated and stirred at 200° C. for 120 minutes. Thereafter, the mixture was cooled with cooling water and dried under reduced pressure to obtain alumina particles 1. The number average primary particle diameter of the alumina particles 1 obtained was 20 nm.

In addition, alumina particles 2 to 5 having different number average primary particle diameters were obtained by adjusting the reaction conditions.

<Fabrication of Toner 1>

<External Additive Adding Step>

The following two kinds of external additive particles were added to 100 parts by mass of toner base particles 1 and the mixture was placed in Henschel mixer (registered trademark) model “FM20C./I” (manufactured by NIPPON COKE & ENGINEERING CO., LTD.). The number of revolutions of the stirring blade was set so that the peripheral velocity of the blade tip was 40 m/s and stirring was performed for 15 minutes to fabricate toner 1.
Alumina particles 1 0.5 parts by mass
Hydrophobic silica particles (number average primary particle diameter: 30 nm) 1.5 parts by mass.

Incidentally, the temperature at the time of mixing of the two kinds of external additive particles with the toner base particles 1 was set to be 40° C.±1° C. The temperature inside the Henschel mixer (registered trademark) was controlled by allowing the cooling water to flow into the outer bath of the Henschel mixer (registered trademark) at a flow rate of 5 L/min in a case in which the temperature reached 41° C. and allowing the cooling water to flow so that the flow rate of the cooling water was 1 L/min in a case in which the temperature reached 39° C.

<Fabrication of Toner 2 to 12>

In addition, toner 2 was obtained in the same manner as in the fabrication of toner 1 except that the toner base particles 1 were changed to the toner base particles 2.

In addition, toner 3 was obtained in the same manner as in the fabrication of toner 1 except that the toner base particles 1 were changed to the toner base particles 3.

In addition, toner 4 was obtained in the same manner as in the fabrication of toner 1 except that the toner base particles 1 were changed to the toner base particles 4.

In addition, toner 5 was obtained in the same manner as in the fabrication of toner 1 except that the toner base particles 1 were changed to the toner base particles 5.

In addition, toner 6 was obtained in the same manner as in the fabrication of toner 1 except that the alumina particles 1 were changed to the alumina particles 2.

In addition, toner 7 was obtained in the same manner as in the fabrication of toner 1 except that the alumina particles 1 were changed to the alumina particles 3.

In addition, toner 8 was obtained in the same manner as in the fabrication of toner 1 except that the alumina particles 1 were changed to the alumina particles 4.

In addition, toner 9 was obtained in the same manner as in the fabrication of toner 1 except that the alumina particles 1 were changed to the alumina particles 5.

In addition, toner 10 was obtained in the same manner as in the fabrication of toner 1 except that the toner base particles 1 were changed to the toner base particles 6.

In addition, toner 11 was obtained in the same manner as in the fabrication of toner 1 except that the alumina particles 1 were eliminated but the amount of hydrophobic silica particles were increased by the amount of alumina particles 1.

In addition, toner 12 was obtained in the same manner as in the fabrication of toner 1 except that the alumina particles 1 were changed to hydrophobic titania particles (number average primary particle diameter: 20 nm).

TABLE 1

| | Toner | | | | | | |
|---|---|---|---|---|---|---|---|
| | | | Acid chain | | Alcohol chain | | Particle |
| | Crystalline | Acid | length | Alcohol | length | | diameter |
| | resin | component | (C_{acid}) | component | (C_{alcohol}) | Alumina | (nm) |
| Toner 1 | Crystalline | 1,10-decanedioic | 10 | 1,6- | 6 | Alumina 1 | 20 |
| | polyester 1 | acid | | hexanediol | | | |
| Toner 2 | Crystalline | 1,12-dodecanedioic | 12 | 1,9- | 9 | Alumina 1 | 20 |
| | polyester 2 | acid | | nonanediol | | | |
| Toner 3 | Crystalline | 1,14-tetradecanedioic | 14 | 1,11- | 11 | Alumina 1 | 20 |
| | polyester 3 | acid | | undecanediol | | | |
| Toner 4 | Crystalline | Adipic acid | 6 | 1,4- | 4 | Alumina 1 | 20 |
| | polyester 4 | | | butanediol | | | |
| Toner 5 | Crystalline | Succinic acid | 4 | 1,3- | 3 | Alumina 1 | 20 |
| | polyester 5 | | | propanediol | | | |
| Toner 6 | Crystalline | 1,10-decanedioic | 10 | 1,6- | 6 | Alumina 2 | 40 |
| | polyester 1 | acid | | hexanediol | | | |
| Toner 7 | Crystalline | 1,10-decanedioic | 10 | 1,6- | 6 | Alumina 3 | 45 |
| | polyester 1 | acid | | hexanediol | | | |
| Toner 8 | Crystalline | 1,10-decanedioic | 10 | 1,6- | 6 | Alumina 4 | 10 |
| | polyester 1 | acid | | hexanediol | | | |
| Toner 9 | Crystalline | 1,10-decanedioic | 10 | 1,6- | 6 | Alumina 5 | 8 |
| | polyester 1 | acid | | hexanediol | | | |
| Toner 10 | Nil | Nil | Nil | Nil | Nil | Alumina 1 | 20 |
| Toner 11 | Crystalline | 1,10-decanedioic | 10 | 1,6- | 6 | Without | — |
| | polyester 1 | acid | | hexanediol | | alumina | |
| Toner 12 | Crystalline | 1,10-decanedioic | 10 | 1,6- | 6 | Titania | 20 |
| | polyester 1 | acid | | hexanediol | | | |

In Table 1 above, crystalline polyesters 1 to 5 mean crystalline polyester resins 1 to 5. In addition, the acid chain length (C_{acid}) means the number of carbon atoms (the number of carbon atoms in the main chain of the structural unit derived from the polycarboxylic acid in the crystalline polyester resin) in the acid component used in the synthesis (polymerization) of crystalline polyester resin. In addition, the alcohol chain length (C_{alcohol}) means the number of carbon atoms (the number of carbon atoms in the main chain of the structural unit derived from the polyhydric alcohol in the crystalline polyester resin) in the alcohol component used in the synthesis (polymerization) of crystalline polyester resin. In addition, alumina 1 to 5 means alumina particles 1 to 5 used as external additive particles, and titania means hydrophobic titania particles used as external additive particles. In addition, the particle diameter (nm) means the number average primary particle diameter (nm).

<<Fabrication of Carrier>>

(Fabrication of Alumina Particles 1 for Carrier)

Alumina particles 1 for carrier having a number average primary particle diameter of 300 nm were obtained in the same manner as in the fabrication of alumina particles 1 for external additive except that the reaction conditions were adjusted.

(Fabrication of Particles 2 for Carrier Containing Alumina and having Core-Shell Structure)

Alumina particles 2 (core portion) for carrier having a number average primary particle diameter of 270 nm were obtained in the same manner as in the fabrication of alumina particles 1 for external additive except that the reaction conditions were adjusted. In 2.5 liters of water, 200 g of the alumina particles 2 (core portion) for carrier obtained were dispersed to obtain a water suspension. This suspension was heated to and maintained at 80° C. Subsequently, a solution separately prepared by dissolving 75 g of indium chloride (InCl₃) and 10 g of stannic chloride (SnCl₄.5H₂O) in 800 ml of 2 N hydrochloric acid and 12% by mass aqueous ammonia were added thereto dropwise so as to maintain the pH of the suspension at 7 to 8. After completion of the dropwise addition, the treated suspension was filtered and washed, and the cake obtained was dried at 120° C. to obtain a dry powder.

Subsequently, the dry powder obtained was subjected to a heat treatment at 500° C. for 1.5 hours in a nitrogen gas stream (1 liter/min) to obtain the intended particles 2 for carrier which contained alumina and had a core-shell structure and a number average primary particle diameter of 300 nm. The particles 2 containing alumina are particles having a core-shell structure in which the core portion is the alumina particles 2 and the shell portion contains indium and tin (indium oxide and tin dioxide).

(Fabrication of Particles 3 to 6 for Carrier Containing Alumina and having Core-Shell Structure)

In addition, particles 3 to 6 for carrier which contained alumina and had a core-shell structure were obtained in the same manner as in the fabrication of particles 2 for carrier which contained alumina and had a core-shell structure except that alumina particles 3 to 6 (core portion) for carrier to be described below were used and the particle diameters of the particles 3 to 6 containing alumina were changed as presented in Table 2. The particles 3 to 6 containing alumina are particles having a core-shell structure in which the core portion is the alumina particles 3 to 6 and the shell portions all contain indium and tin (indium oxide and tin dioxide).

Alumina particles 3 (core portion) for carrier having a number average primary particle diameter of 470 nm were obtained in the same manner as in the fabrication of alumina particles 1 for external additive except that the reaction conditions were adjusted.

In addition, alumina particles 4 (core portion) for carrier having a number average primary particle diameter of 570 nm were obtained in the same manner as in the fabrication of alumina particles 1 for external additive except that the reaction conditions were adjusted.

In addition, alumina particles 5 (core portion) for carrier having a number average primary particle diameter of 70 nm were obtained in the same manner as in the fabrication of alumina particles 1 for external additive except that the reaction conditions were adjusted.

In addition, alumina particles 6 (core portion) for carrier having a number average primary particle diameter of 20 nm were obtained in the same manner as in the fabrication of alumina particles 1 for external additive except that the reaction conditions were adjusted.

<Fabrication of Carrier 1>

| | | |
|---|---|---|
| Silicone resin solution | 132.2 | parts |
| [Solid content: 23% by mass | | |
| (SR2410: manufactured by Dow Corning Toray Co., Ltd.)] | | |
| Aminosilane | 0.66 | part |
| [Solid content: 100% by mass | | |
| (SH6020: manufactured by Dow Corning Toray Co., Ltd.)] | | |
| Particles 2 for carrier containing alumina | 31 | parts |
| Toluene | 300 | parts |

were dispersed for 10 minutes using a homomixer to obtain a resin layer forming solution. Fired ferrite powder having an average particle diameter of 35 μm was used as the core material, and the resin layer forming solution was applied onto the surface of the core material so as to have a dry film thickness of 0.15 μm at an internal temperature of coater of 40° C. using a Spira coater (manufactured by OKADA SEIKO CO., LTD.) and dried. The carrier obtained was fired by being left to stand in an electric furnace at 300° C. for 1 hour. After being cooled, the ferrite powder bulk was crushed using a sieve having an opening of 63 μm to obtain carrier 1 having a weight average particle diameter of 35 μm. The carrier 1 is carrier particles having a resin layer containing a silicone resin and particles 2 containing alumina on the surface of a core material.

With regard to the measurement of the average particle diameter of the core material, measurement was performed in a range set to 0.7 μm or more and 125 μm or less using SRA type of Microtrac Particle Size Analyzer (manufactured by Nikkiso Co., Ltd.) in the same manner as in the weight average particle diameter of carrier. In addition, methanol was used as a dispersing liquid, and the refractive index was set to 1.33, and the refractive indexes of the carrier and the core material were set to 2.42.

<Fabrication of Carrier 2>

In addition, carrier 2 was obtained in the same manner as in the fabrication of carrier 1 except that the prescription of the resin layer forming solution to be used in the formation of the resin layer of the carrier was changed to the following.

Prescription of resin layer forming solution;

| | | |
|---|---|---|
| Poly methyl methacrylate (Mw: 500000) | 20 | parts |
| Silicone resin solution | 185.8 | parts |
| [Solid content: 20% by mass | | |
| (SR2410: manufactured by Dow Corning Toray Co., Ltd.)] | | |
| Aminosilane | 0.42 | part |
| [Solid content: 100% by mass | | |
| (SH6020: manufactured by Dow Corning Toray Co., Ltd.)] | | |
| Particles 2 for carrier containing alumina | 66.2 | parts |
| Toluene | 800 | parts |

<Fabrication of Carriers 3 to 8>

In addition, carriers 3 to 8 were obtained by changing the particles 2 for carrier containing alumina of the carrier 1 as presented in the following Table 2.

<Fabrication of Carrier 9>

In addition, carrier 9 was obtained in the same manner as in the fabrication of carrier 2 except that the prescription of the resin layer forming solution to be used in the formation of the resin layer of the carrier 2 was changed to the following.

Prescription of resin layer forming solution;

| | | |
|---|---|---|
| Poly methyl methacrylate (Mw: 500000) | 66 | parts |
| Particles 2 for carrier containing alumina | 66.2 | parts |
| Toluene | 800 | parts |

TABLE 2

| | Carrier | | | | |
|---|---|---|---|---|---|
| | | Particles containing alumina in resin layer | | | |
| | Resin | | | Core particle | Particle |
| | constituting | Particle | Kind of | diameter | diameter |
| | resin layer | No. | particle | (nm) | (nm) |
| Carrier 1 | Silicone resin | Alumina 2 | Indium-tin/ | 270 | 300 |
| | | for carrier | alumina 2 | | |
| Carrier 2 | Acrylic resin + | Alumina 2 | Indium-tin/ | 270 | 300 |
| | silicone resin | for carrier | alumina 2 | | |
| Carrier 3 | Silicone resin | Alumina 1 | Alumina 1 | Nil | 300 |
| | | for carrier | | | |
| Carrier 4 | Silicone resin | Nil | Nil | Nil | Nil |
| Carrier 5 | Silicone resin | Alumina 3 | Indium-tin/ | 470 | 500 |
| | | for carrier | alumina 3 | | |
| Carrier 6 | Silicone resin | Alumina 4 | Indium-tin/ | 570 | 600 |
| | | for carrier | alumina 4 | | |
| Carrier 7 | Silicone resin | Alumina 5 | Indium-tin/ | 70 | 100 |
| | | for carrier | alumina 5 | | |
| Carrier 8 | Silicone resin | Alumina 6 | Indium-tin/ | 20 | 50 |
| | | for carrier | alumina 6 | | |
| Carrier 9 | Acrylic resin | Alumina 2 | Indium-tin/ | 270 | 300 |
| | | for carrier | alumina 2 | | |

In Table 2 above, the alumina 1 for carrier in the column of the particle No. means the alumina particles 1 for carrier. In addition, the alumina 2 to 6 for carrier mean the particles 2 to 6 for carrier which contain alumina and have a core-shell structure. In addition, the alumina 1 in the column of the kind of particle means alumina particles 1. Indium-tin/alumina 2 to 6 mean particles having a core-shell structure in which the core portion is the alumina particles 2 to 6 and the shell portions all contain indium and tin (indium oxide and tin dioxide).

<<Fabrication of Two-Component Developer>>

### Example 1

### fabrication of Two-Component Developer 1

After 1.0 kg of the carrier 1 fabricated above was weighed and put in Micro V Mixer (manufactured by TSUTSUI SCIENTIFIC INSTRUMENTS CO., LTD.), then the toner 1 was added thereto so that the toner concentration was 7.5% by mass, and these were mixed at a rotational speed of 45 rpm for 30 minutes to fabricate two-component developer 1.

### <Examples 2 to 16 and Comparative Examples 1 to 4

### Fabrication of Two-Component Developers 2 to 20

Two-component developers 2 to 20 were fabricated in the same manner as in the fabrication of the two-component developer 1 except that the combination of carrier and toner was changed to the combinations presented in the following Table 3.

<<Evaluation Contents>>

[Evaluation 1: Minimum Fixing Temperature]

In the digital printer “bizhub PRESS (registered trademark) C1070” (manufactured by Konica Minolta, Inc.), the fixing device was modified so that the pressure and the process speed (nip time) in the nip region were able to be changed and further modified so that the surface temperature of the heat roller for fixing was able to be changed in a range of 100° C. to 210° C. The printing machine was loaded with two-component developers 1 to 20, respectively.

The amount attached on high-quality paper “CF paper” (manufactured by Konica Minolta, Inc.) of A4 size was set to 5.0 g/m² in an environment of normal temperature and normal humidity (20° C., 55% RH). Thereafter, a fixing experiment in which an image having a size of 100 mm x 100 mm was fixed was repeatedly performed from 100° C. to 170° C. while changing the fixing temperature set in steps of 5° C.

The printed matter obtained at each fixing temperature was visually examined, and the lowest temperature at which the entire toner was fixed on the paper without being attached to the fixing device was taken as the minimum fixing temperature (° C.).

Incidentally, a case in which the minimum fixing temperature exceeded 135° C. was judged as failure and a case in which the minimum fixing temperature was 135° C. or less was judged as success.

[Evaluation 2: Spent Property of Toner on Carrier]

The digital printer “bizhub PRESS (registered trademark) C1070” (manufactured by Konica Minolta, Inc.) was loaded with the two-component developers 1 to 20, respectively and subjected to the following evaluation. In the present evaluation apparatus, printing is performed by an electrophotographic image forming method having a charging step, an exposure step, a development step, and a transfer step. In the following evaluation of “spent property of toner on carrier”, evaluation is performed using each of the evaluation apparatuses after being subjected to one million sheets of durable printing. Here, the printing condition of “one million sheets of durable printing” means that a character chart having a coverage rate of 10% was printed one million sheets in an environment of 10° C. and 15% RH.

After one million sheets of durable printing, the two-component developer was washed with an aqueous surfactant solution to collect the carrier particles from the two-component developer. In 100 mL of methyl ethyl ketone, 3 g of these carrier particles was dissolved, the transmittance of light having a wavelength of 630 nm in the solution obtained was determined, and the spent property was judged as failure when the transmittance was less than 85% and as success when the transmittance was 85% or more.

[Evaluation 3: Fogging]

The digital printer “bizhub PRESS (registered trademark) C1070” (manufactured by Konica Minolta, Inc.) was loaded with the two-component developers 1 to 20, respectively and subjected to the following evaluation. In the present evaluation apparatus, printing is performed by an electrophotographic image forming method having a charging step, an exposure step, a development step, and a transfer step. In the evaluation of “fogging at HH” in the following Table 3, a character image having a coverage rate of 5% was printed 300,000 sheets in a normal temperature and normal humidity environment (20° C., 50% RH). Thereafter, blank paper was printed after a character image having a coverage rate of 5% was printed 300,000 sheets in a high temperature and high humidity (HH) environment (30° C., 80% RH) and at the initial stage (before being printed in a normal temperature and normal humidity environment), and fogging was evaluated by the blank paper density of the transfer material. The white paper density of the transfer material was measured at 20 locations of A4 size, and the average value thereof was taken as the white paper density. The density measurement was performed using a reflection densitometer “RD-918” (manufactured by MACBETH CORPORATION). Incidentally, the fogging at HH was judged as failure when the white paper density was 0.010 or more and as success when the white paper density was less than 0.010.

TABLE 3

| | | | Minimum | Toner | |
|---|---|---|---|---|---|
| | | | fixing | spent on | |
| | | | temperature | carrier | Fogging |
| | | | (° C.) | (%) | at HH |
| Example 1 | Toner 1 | Carrier 1 | 120 | 97 | 0.003 |
| Example 2 | Toner 2 | Carrier 1 | 125 | 97 | 0.006 |
| Example 3 | Toner 3 | Carrier 1 | 130 | 97 | 0.007 |
| Example 4 | Toner 4 | Carrier 1 | 115 | 94 | 0.004 |
| Example 5 | Toner 5 | Carrier 1 | 115 | 92 | 0.005 |
| Example 6 | Toner 6 | Carrier 1 | 120 | 92 | 0.006 |
| Example 7 | Toner 7 | Carrier 1 | 120 | 88 | 0.007 |
| Example 8 | Toner 8 | Carrier 1 | 125 | 93 | 0.002 |
| Example 9 | Toner 9 | Carrier 1 | 130 | 87 | 0.002 |
| Example 10 | Toner 1 | Carrier 2 | 120 | 92 | 0.002 |
| Example 11 | Toner 1 | Carrier 3 | 125 | 97 | 0.005 |
| Example 12 | Toner 1 | Carrier 4 | 120 | 90 | 0.004 |
| Example 13 | Toner 1 | Carrier 5 | 125 | 97 | 0.005 |
| Example 14 | Toner 1 | Carrier 6 | 130 | 98 | 0.006 |
| Example 15 | Toner 1 | Carrier 7 | 120 | 94 | 0.007 |
| Example 16 | Toner 1 | Carrier 8 | 120 | 92 | 0.008 |
| Comparative | Toner 10 | Carrier 1 | 140 | 99 | 0.008 |
| Example 1 | | | | | |
| Comparative | Toner 11 | Carrier 1 | 120 | 83 | 0.011 |
| Example 2 | | | | | |
| Comparative | Toner 12 | Carrier 1 | 120 | 82 | 0.010 |
| Example 3 | | | | | |
| Comparative | Toner 1 | Carrier 9 | 120 | 81 | 0.001 |
| Example 4 | | | | | |

The unit of the numerical value in the column of “minimum fixing temperature” in Table 3 above is “° C”. In addition, the numerical value in the column of “spent property of toner on carrier” denotes the transmittance of light having a wavelength of 630 nm in a solution obtained by collecting the carrier particles from the two-component developer after one million sheets of durable printing and dissolving the carrier particles in methyl ethyl ketone in the evaluation, and the unit thereof is “%”.

From the results of Table 3 above, it has been found that the low temperature fixing temperature, spent of toner on the carrier, fogging at HH are all judged as success, the low-temperature fixability is excellent, and the spent resistance and fogging resistance can be improved in Examples 1 to 16 (two-component developers 1 to 16) having the configuration according to the present invention.

Examples 1 to 5 in which the number of carbon atoms C_{alcohol} in the main chain of a structural unit derived from a polyhydric alcohol of the crystalline polyester resin contained in the binder resin and the number of carbon atoms C_{acid} in the main chain of a structural unit derived from a polycarboxylic acid were changed were compared with one another. In Example 3 in which the respective numbers of carbon atoms are great (exceeding the upper limit values in the above relational expressions (1) and (2)), it has been confirmed that the crystalline polyester resin is in an incompatible state with respect to the amorphous resin, the low-temperature fixing effect is less likely to be attained as compared to the that in other Examples 1, 2, 4, and 5, and the low-temperature fixing temperature is 130° C. to be relatively high. Meanwhile, in Example 5 in which the respective numbers of carbon atoms are small (below the lower limit values in the above relational expressions (1) and (2)), it has been confirmed that the spent suppressing effect is less likely to be attained as compared to the that in other Examples 1 to 4. In addition, in Examples 1, 2, and 4 in which the respective numbers of carbon atoms satisfy the above relational expressions (1) and (2), it has been confirmed that the low-temperature fixability is excellent and further the spent suppressing effect is also high. Particularly, in Example 1 in which the respective numbers of carbon atoms satisfy the above relational expressions (la) and (2a), it has been confirmed that the low-temperature fixability is excellent, the spent suppressing effect is higher, and further the fogging suppressing effect is also higher.

Next, Examples 1 and 6 to 9 in which the number average primary particle diameter of alumina particles of an external additive was changed were compared with one another. In Example 9 in which the number average primary particle diameter is smaller than the lower limit value of 10 to 40 nm, it has been confirmed that alumina particles are excessively buried in the toner base particles, thus the effect of decreasing the adhesive force is diminished as compared to that in Examples 1, 6, and 8, and as a result, the spent suppressing effect is slightly diminished. Meanwhile, in Example 7 in which the number average primary particle diameter is larger than the upper limit value of 10 to 40 nm, it has been confirmed that the alumina particles are more likely to be detached as compared to those in Examples 1, 6, and 8, and as a result, the spent suppressing effect is slightly diminished. In Examples 1, 6, and 8 in which the number average primary particle diameter is in the range of 10 to 40 nm, it has been confirmed that the spent suppressing effect is sufficiently high. Particularly, in Example 1 in which the number average primary particle diameter is in the range of 13 to 25 nm, it has been confirmed that the spent suppressing effect is higher.

Next, Examples 1 and 13 to 16 in which the number average primary particle diameter of the particles which contain alumina and are contained in the resin layer of the carrier was changed were compared with one another. In Example 16 in which the number average primary particle diameter is smaller than the lower limit value of 100 to 500 nm, it has been confirmed that the spent suppressing effect is slightly smaller and the fogging suppressing effect is slightly smaller as compared to those in Examples 1, 13, and 15. Meanwhile, in Example 14 in which the number average primary particle diameter is larger than the upper limit value of 100 to 500 nm, it has been confirmed that the low-temperature fixing temperature is 130° C. to be relatively higher as compared to that in Examples 1, 13, and 15. In Examples 1, 13, and 15 in which the number average primary particle diameter is in the range of 100 to 500 nm, it has been confirmed that the low-temperature fixability is excellent and the spent suppressing effect and the fogging suppressing effect are also higher. Particularly, in Example 1 in which the number average primary particle diameter is in the range of 200 to 400 nm, it has been confirmed that the low-temperature fixability is excellent, the spent suppressing effect is higher, and further the fogging suppressing effect is more remarkable. Furthermore, when Example 12 in which particles containing alumina are not contained in the resin layer of the carrier and Example 1 in which particles containing alumina are contained in the resin layer of the carrier are compared with each other, it is possible to impart irregularities to the surface of the carrier resin and to decrease the contact area with the toner by containing particles containing alumina in the resin layer of the carrier in Example 1. In addition, it has been confirmed that the heat generated by the mixing of the developer is released from the carrier as alumina having a high thermal conductivity is present, and the influence of the heat on the toner is suppressed, thus the spent resistance is improved as compared to that in Example 12.

Next, Example 1 in which the particles which contain alumina and are contained in the resin layer of the carrier have a core-shell structure, alumina is contained in the core portion, and indium and tin are contained in the shell portion and Example 11 in which the particles do not have the shell portion were compared with each other. In Example 1, it has been confirmed that as the resistance of the particles decreases and charging is suppressed, the amount of transfer to the toner can be decreased, inhibition of fixing can be suppressed, and the low-temperature fixability is superior and the fogging suppressing effect is also higher as compared to those in Example 11.

Next, Example 1 in which a silicone resin is used in the resin layer of the carrier and Example 10 in which a silicone resin and an acrylic resin are concurrently used in the resin layer were compared with each other. In Example 1 in which a silicone resin having a low surface energy is used, it has been confirmed that the toner is less likely to be spent on the carrier and the spent is further suppressed as compared with Example 10 in which an acrylic resin is concurrently used. Meanwhile, it has been found that Example 10 in which an acrylic resin is concurrently used is slightly superior to Example 1 in the fogging suppressing effect. From this fact, it has been found that a balance between the spent suppressing effect and the fogging suppressing effect can be achieved by mixing an appropriate amount of acrylic resin with a silicone resin.

On the other hand, among Comparative Examples 1 to 4 (two-component developers 17 to 20), in Comparative Example 1 in which a crystalline polyester resin is not contained as a binder resin of the toner, it has been confirmed that there is a problem that the low-temperature fixability cannot be maintained.

In addition, Comparative Examples 2 and 3 are examples in which alumina particles are not used but silica particles and titania particles are used as an external additive of the toner. The silica particles and titania particles used in Comparative Examples 2 and 3 have a lower thermal conductivity than alumina, thus an increase in the temperature of the developer cannot be suppressed and the softening of the toner also cannot be suppressed. For this reason, it has been confirmed that the adhesive force of the toner cannot be sufficiently diminished in the developing machine as well, and the effect of ameliorating the spent property is insufficient, moreover, there is a problem that the stability of charging is low and fogging deteriorates.

In addition, in Comparative Example 4 in which the resin layer of the carrier does not contain a silicone resin, it has been confirmed that there is a problem that the toner is likely to be spent on the carrier and the effect of ameliorating the spent property is hardly attained since a silicone resin having a low surface energy is not used as a carrier resin.

Although embodiments of the present invention have been described in detail, the disclosed embodiments are made for the purpose of example only and not limitation. The scope of the present invention should be interpreted by terms of the appended claims.

What is claimed is:

1. A two-component developer for electrostatic charge image development, comprising toner containing: at least a binder resin and an external additive on a surface; and a carrier containing a resin layer at least on a surface of a core material, wherein
the binder resin contains a crystalline polyester resin, the external additive contains alumina particles, and the resin layer contains a silicone resin.

2. The two-component developer for electrostatic charge image development according to claim 1, wherein the crystalline polyester resin satisfies following relational expressions (1) and (2), where C_{alcohol} denotes a number of carbon atoms in a main chain of a structural unit derived from a polyhydric alcohol and C_{acid} denotes a number of carbon atoms in a main chain of a structural unit derived from a polycarboxylic acid.
[Math. 1]
6≤C_{acid}≤12 Relational expression (1):
4≤C_{alcohol}≤9 Relational expression (2):

3. The two-component developer for electrostatic charge image development according to claim 1, wherein a number average primary particle diameter of the alumina particles is in a range of 10 nm or more and 40 nm or less. 2 0 4. The two-component developer for electrostatic charge image development according to claim 1, wherein the resin layer contains particles containing alumina having a number average primary particle diameter of 100 nm or more and 500 nm or less.

5. The two-component developer for electrostatic charge image development according to claim 4, wherein the particles containing alumina have a core-shell structure, wherein
alumina is contained in a core portion and at least either of indium or tin is contained in a shell portion.
